(19) United States
(12) Patent Application Publication
(10) Pub. No.: US 2022/0331796 A1
(43) Pub. Date: Oct. 20, 2022

(54) MATERIAL TRANSFER DEVICE AND METHOD OF USE THEREOF

(71) Applicant: DrugArray, Inc., La Jolla, CA (US)

(72) Inventors: Dayu TENG, San Diego, CA (US); Daniel Joseph BRAUN, San Diego, CA (US); Jieying LI, La Jolla, CA (US); Farzad SAFAVI, La Jolla, CA (US); Rob SHANAHAN, La Jolla, CA (US)

(21) Appl. No.: 17/761,112

(22) PCT Filed: Oct. 6, 2020
(86) PCT No.: PCT/US2020/054432

§ 371 Date: Mar. 16, 2022

Related U.S. Application Data
(60) Provisional application No. 62/911,811, filed on Oct. 7, 2019.

(51) Int. Cl. B01L 3/00

(52) U.S. Cl. CPC B01L 3/502715; B01L 2200/027; B01L 2300/0829; B01L 2200/16; B01L 2400/0409; B01L 2300/0609

(57) ABSTRACT

The transfer systems, devices, kits, and methods described here may be used to facilitate the transfer of a material (e.g., a fluid) to or from a donor container, e.g., to or from wells of a donor plate while leaving target agents attached to the wells. The systems may comprise a donor plate, a transfer adapter, and a receiver plate that may be coupled to form a transfer assembly. The transfer adapter may comprise a planar sheet and a plurality of openings, and it may be configured to regulate the flow of fluid out of the wells. The transfer assembly may be placed into a centrifuge, and the fluid transfer force produced by the centrifuge may cause fluid to flow out of the wells of the donor plate, through the openings in the transfer adapter, and into the receiver plate.

### CROSS-REFERENCE TO RELATED APPLICATION

This application claims priority to U.S. Provisional Patent Application Ser. No. 62/911,811, filed Oct. 7, 2019, which application is herein incorporated by reference in its entirety for all purposes.

### FIELD

The present invention relates generally to tools for material transfer, such as fluid transfer into and/or out of a multi-well plate, e.g., decanting and/or loading a multi-well plate, or transferring liquid between multi-well plates or between a multi-well plate and another structure.

### BACKGROUND

Multi-well plates are used in a wide range of laboratory applications, such as performing chemical, biological, or pharmacological tests on multiple samples in parallel. A multi-well plate may have a grid of small, open divots or wells, and each well may hold a different sample under evaluation. For some evaluations, the samples may include target agents immobilized on a base of each well. These target agents can include but are not limited to proteins, nucleic acids, cells, microorganisms (e.g., bacteria, fungi), plants (e.g., algae), viruses, small molecule drugs or other chemical compounds, or antigen-antibody complexes. Generally, the samples under evaluation also include a fluid which partially fills each well and immerses the target agents. After a reaction, binding, or other process occurs in the wells, it is often desirable to perform tests on the fluid component of each sample and/or on the target agents separately, or to replace or supplement the fluid component of each sample with a new fluid. Thus, techniques have been developed to transfer fluid to or from the wells of the multi-well plate while leaving at least some of the target agents attached to the wells.

While several techniques and devices have been developed to facilitate the transfer of fluid to or from wells of a multi-well plate, they all have significant drawbacks. For example, vacuum suction is often used to remove fluid in both manual and automatic/robotic techniques. However, the force and flow created by a suction apparatus, such as a pipette, are not evenly distributed in a well; the suction force and flow are greatest near the tip of the suction apparatus. Vacuum suction can therefore affect different portions of a sample differently, which can introduce unwanted variability within one sample and between different samples. For example, target agents near the tip of the suction apparatus may be inadvertently damaged or detached and removed from the well, while target agents farther from the tip may be unaffected.

In addition, manual techniques are often slow and laborious, even if multi-channel devices are used to load or remove fluid from more than one well at a time. This is especially true if fluid is transferred to or from multi-well plates with hundreds of wells. Manual devices generally do not have enough channels to transfer fluid to or from all of the wells simultaneously, and some of the processes occurring in the wells can be time-sensitive. Thus, transferring the fluid to or from different wells at different times can be another source of unwanted variability between different samples. Additionally, use of multi-channel devices for fluid transfer can result in cross-contamination between wells of the multi-well plate. Automated or robotic devices, such as liquid handlers, generally have the disadvantage of being expensive.

Therefore, a significant need exists for an improved device or system that facilitates the transfer of fluid to or from the wells of a multi-well plate. Such a device or system should be capable of transferring the fluid to or from every well simultaneously while leaving the target agents immobilized in the wells and substantially undisturbed. The forces involved in fluid transfer should be uniform within each well and between different wells to decrease the variability between samples of fluid or target agents. Furthermore, an improved fluid transfer device or system should be relatively low-cost but require minimal manual work to achieve the desired result.

### BRIEF SUMMARY

In one aspect, disclosed herein is a device for transferring a material such as a fluid, comprising: a planar sheet having a first planar surface, a second planar surface, and a plurality of openings, wherein each opening of the plurality of openings extends between the first planar surface and the second planar surface; a plurality of primary extensions, wherein each primary extension of the plurality of primary extensions protrudes from the first planar surface and comprises a primary lumen; and a plurality of secondary extensions, wherein each secondary extension of the plurality of secondary extensions protrudes from the second planar surface and comprises a secondary lumen, and wherein each secondary lumen is aligned with an opening and a primary lumen to create a continuous transfer lumen. In some embodiments, each primary extension of the plurality of primary extensions in the device has an inner cross-sectional area and an outer cross-sectional area, and the inner cross-sectional area is greater than the outer cross-sectional area. In any of the preceding embodiments, each primary extension can have at least two regions, and each of the at least two regions can have a different angle relative to the planar sheet. In some embodiments, the at least two regions comprise a first region proximal to the planar sheet and a second region distal to the planar sheet, and the angle of the first region relative to the planar sheet is greater than the angle of the second region relative to the planar sheet.

In any of the preceding embodiments, each primary extension of the plurality of primary extensions can comprise at least one structure configured to fluidly connect to the primary lumen. In some embodiments, the at least one structure comprises an aperture, a hole, a slit, a gap, a notch, a grove, or a channel. In some embodiments, the primary extension comprises four slits configured to fluidly connect to the primary lumen.

In one aspect, disclosed herein is a system for transferring fluid, comprising: a transfer adapter, wherein the transfer adapter comprises a first side, a second side, and a plurality of openings, and wherein each opening of the plurality of openings extends between the first side and the second side; and a receiver plate, wherein the receiver plate is configured to removably couple to the second side of the transfer adapter. In some embodiments, the system further comprises a donor plate comprising one well or a plurality of wells, and the donor plate is configured to removably couple to the first side of the transfer adapter. In some embodiments, each opening of the plurality of openings aligns with a different well of the plurality of wells when the transfer adapter and the donor plate are removably coupled.

In any of the preceding embodiments, the transfer adapter can comprise a plurality of primary extensions. In any of the preceding embodiments, each primary extension of the plurality of primary extensions can be configured to seal against an interior surface of a different well of the plurality of wells of the donor plate.

In any of the preceding embodiments, the receiver plate can comprise a plurality of receiver wells. In any of the preceding embodiments, each opening of the plurality of openings can align with a different receiver well of the plurality of receiver wells when the transfer adapter and the receiver plate are removably coupled.

In any of the preceding embodiments, the transfer adapter can comprises a plurality of secondary extensions, and each secondary extension of the plurality of secondary extensions can be configured to be inserted into a different receiver well of the plurality of receiver wells.

In any of the preceding embodiments, the transfer adapter can comprise an adhesive on the first side and/or the second side.

In any of the preceding embodiments, the transfer adapter can comprise a plurality of leaflets adjacent to each opening of the plurality of openings, and at least one leaflet can be moveable between an open position and a closed position.

In any of the preceding embodiments, the transfer adapter can be configured to allow the flow of a fluid through the plurality of openings only when an external force is applied to the fluid.

In one aspect, disclosed herein is a method for transferring a material such as a fluid, comprising: coupling a transfer adapter, a donor plate, and a receiver plate to form a transfer assembly in a first position (e.g., an upright position), wherein in the first position the transfer adapter is positioned below the receiver plate and above the donor plate; and centrifuging the transfer assembly around an axis of rotation, wherein when the transfer assembly is centrifuged, the donor plate is positioned closer to the axis of rotation than the transfer adapter and the receiver plate, wherein the transfer adapter comprises a plurality of openings and the donor plate comprises a plurality of wells, and wherein each opening of the plurality of openings is aligned with a different well of the plurality of wells when the transfer assembly is in the first position and when the transfer assembly is centrifuged. In some embodiments, the method further comprises uncoupling the donor plate from the transfer adapter.

In any of the preceding embodiments, a seal can be formed between each well of the plurality of wells and the transfer adapter when the donor plate and the transfer adapter are coupled. In some embodiments, the seal allows fluid to flow from the plurality of wells through the plurality of openings but blocks the flow of fluid between wells of the plurality of wells.

In any of the preceding embodiments, each well of the plurality of wells can comprise a target agent attached the well and a fluid. In some embodiments, the target agent remains attached to the well after centrifuging.

In any of the preceding embodiments, the fluid can be transferred to the receiver plate after centrifuging.

In any of the preceding embodiments, the receiver plate can comprise a plurality of receiver wells, and each opening of the plurality of openings can be aligned with a different receiver well of the plurality of receiver wells when the transfer assembly is in the first position and when the transfer assembly is centrifuged. In some embodiments, a seal is formed between each receiver well of the plurality of receiver wells and the transfer adapter when the receiver plate and the transfer adapter are coupled. In some embodiments, the seal allows fluid to flow through the plurality of openings to the plurality of receiver wells but blocks the flow of fluid between receiver wells of the plurality of receiver wells.

In one aspect, disclosed herein is a method for transferring a material such as a fluid from and/or to wells of a donor plate comprising a plurality of wells, wherein at least one well comprises a plurality of target agents attached to the well and a fluid, comprising: applying a fluid transfer force to the donor plate, wherein the fluid transfer force has a simultaneous and substantially uniform effect on the plurality of target agents in the at least one well. In some embodiments, each of at least two wells of the plurality of wells comprises a plurality of target agents attached to the well and a fluid, and wherein the fluid transfer force has a simultaneous and substantially uniform effect on the plurality of target agents in every well of the at least two wells.

In one aspect, disclosed herein is a device for transferring a material such as a fluid, comprising: a planar sheet having a first planar surface on a first side and a second planar surface on a second side, a plurality of enclosures (e.g., wells) on the first side having openings on the second side, a plurality of extensions on the second side protruding from the second planar surface and comprising a lumen connected to the openings of the enclosures. In some embodiments, each extension is configured to be inserted into a different receiver well of a receiver plate. In some embodiments, each extension is configured to seal against a different receiver well of a receiver plate.

In any of the preceding embodiments, an inner surface of the extension can be configured to form an angle with an inner wall of the receiver well, and the angle can be about 7 degrees or less.

In any of the preceding embodiments, the device can further comprise an agent in the plurality of enclosures, such as a liquid agent, e.g., a lyophilized agent.

In any of the preceding embodiments, each enclosure of the device can comprise a structure configured to retain and/or dispense an agent. In some embodiments, the structure comprises a protrusion.

In one aspect, disclosed herein is a method for transferring an agent, comprising: coupling the device of any of the preceding embodiments with a receiver plate to form a transfer assembly in a first position (e.g., an upright position); and centrifuging the transfer assembly around an axis of rotation, wherein when the transfer assembly is centrifuged, the device is positioned closer to the axis of rotation than the receiver plate, wherein each opening of the device is aligned with a different receiver well of the receiver plate, whereby an agent in at least one enclosure of the device is transferred to the corresponding receiver well.

In any of the preceding embodiments, the transfer systems, devices, kits, and methods described herein may be used to facilitate the transfer of fluid to or from wells of a multi-well plate while leaving target agents attached to the wells. In one aspect, disclose herein is a transfer adaptor for the transfer of a material such as a fluid. In particular embodiments, the system may comprise a multi-well plate and a transfer adapter, which are separated from each other or coupled to form a transfer assembly. In one aspect, the multi-well plate and the transfer adapter are reversibly coupled. In one aspect, the multi-well plate and the transfer adapter are sealingly coupled to prevent leaking between the multi-well plate and the transfer adapter. In any of the preceding embodiments, the system can further comprise a receiver plate. The receiver plate may be separated from the transfer adaptor, or may be coupled to the transfer adaptor and/or the multi-well plate to form a transfer assembly. In one aspect, the transfer adapter and the receiver plate are reversibly coupled. In one aspect, the transfer adapter and the receiver plate are sealingly coupled to prevent leaking between the transfer adapter and the receiver plate.

In particular embodiments, the multi-well plate may be a standard, off-the shelf multi-well plate, or it may be customized in one or more ways, as described in more detail below. The transfer adapter may comprise a planar sheet and a plurality of openings, and it may be configured to regulate the flow of fluid out of the wells. The receiver plate may comprise one or more receiver wells, and transferred fluid may be contained in the one or more receiver wells. The transfer assembly may be placed into a centrifuge, and the fluid transfer force produced by the centrifuge may cause fluid to flow out of the wells of the multi-well plate, through the openings in the transfer adapter, and into the one or more receiver wells of the receiver plate. The fluid transfer force may be applied uniformly within each well and between different wells, and fluid may be transferred from every well simultaneously.

### BRIEF DESCRIPTION OF THE DRAWINGS

FIGS. 1A and 1C are perspective views of embodiments of a transfer system described herein. FIGS. 1B and 1D are perspective views of embodiments of a transfer assembly described here.

FIG. 2 is an illustrative depiction of an embodiment of a well of a multi-well plate described herein.

FIGS. 3A and 3B are perspective views of an embodiment of a donor plate described herein. FIG. 3A shows an embodiment of a separation well structure inserted within a holding cavity of the donor plate, and FIG. 3B shows the donor plate with the separation well structure removed.

FIGS. 4A-4D are perspective views of an embodiment of a separation well structure described herein. FIG. 4D is a close-up perspective view of an embodiment of the separation well structure.

FIGS. 5A and 5B are perspective views of an embodiment of a directing well structure described herein. FIG. 5C is a cross-sectional view of the directing well structure described herein.

FIGS. 6A and 6B are perspective views of an embodiment of a transfer adapter described here. FIG. 6C is a close-up perspective view of a first side of the transfer adapter.

FIG. 6D is a cross-sectional view of the first side of the transfer adapter inserted into an embodiment of a well of a multi-well plate. FIG. 6E is a close-up perspective view of a second side of the transfer adapter. FIGS. 6F and 6G are cross-sectional views of the second side of the transfer adapter inserted into an embodiment of a receiver well of a receiver plate.

FIG. 7A is a perspective view of embodiments of a transfer adapter and a multi-well plate described here. FIG. 7B is a close-up perspective view of a portion of the transfer adapter. FIG. 7C shows an example of using a centrifugal force to transfer fluid into the receiver wells. FIG. 7D shows the plurality of subdivisions disclosed herein help reduce the interference of unequal meniscus formation.

FIGS. 8A-8C are side views of an embodiment of a transfer assembly described herein in different orientations.

FIG. 9 illustrates a system and method for material transfer described herein.

FIGS. 10A and 10B illustrate a system and method for material transfer described herein.

### DETAILED DESCRIPTION

In the following description, certain specific details are set forth in order to provide a thorough understanding of various embodiments. However, one skilled in the art will understand that the present compounds may be made and used without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising,” are to be construed in an open, inclusive sense, that is, as “including, but not limited to.” In addition, the term “comprising” (and related terms such as “comprise” or “comprises” or “having” or “including”) is not intended to exclude that in other certain embodiments, for example, an embodiment of any composition of matter, composition, method, or process, or the like, described herein, may “consist of” or “consist essentially of” the described features. Headings provided herein are for convenience only and do not interpret the scope or meaning of the claimed embodiments.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used herein, the singular forms “a,” “an,” and “the” include plural referents unless the context clearly dictates otherwise. Thus, for example, reference to “a well” includes one or more wells. Also, and unless specifically stated or obvious from context, as used herein, the term “or” is understood to be inclusive and covers both “or” and “and.”

In some embodiments, the present disclosure refers to a leak-proof seal or a fluidly closed system, particularly when a transfer system is assembled in order to carry out the transfer, e.g., using a centrifuge. A “leak-proof seal” or a “fluidly closed” system means that liquids within a system that comprises one or more containers (e.g., wells), chambers, valves, and/or passages, possibly interconnected and in communication with one another, cannot communicate with the exterior of such a system, and likewise liquids on the exterior of such a system cannot communicate with liquids contained within the interior of the system.

The transfer systems, devices, kits, and methods described here may be used to facilitate the transfer of fluid to or from wells of a multi-well plate. The systems may comprise a donor plate, a transfer adapter, and a receiver plate that may be coupled to form a transfer assembly. The donor plate and/or receiver plate may in some embodiments be any standard multi-well plate, embodiments of which are well-known in the art for use in a variety of laboratory applications. However, in other embodiments, the donor plate and/or receiver plate may comprise one or more features to facilitate interaction with other components of the transfer system or to allow division or combination of wells. The donor plate and/or receiver plate may comprise any number of wells, including, but not limited to standard 6, 24, 96, and 384 well arrangements. At least some of the wells may be filled with fluid and have one or more target agents, such as but not limited to proteins, nucleic acids, cells, microorganisms (e.g., bacteria, fungi), plants (e.g., algae), viruses, small molecule drugs or any chemical compounds, antigen-antibody complexes, or the like, attached to their interior surfaces.

In order for fluid to be transferred to or from the wells in a controlled manner, the donor plate and/or receiver plate may be releasably connected to a transfer adapter. The transfer adapter may comprise a planar sheet and a plurality of openings, arranged, for example, such that each opening aligns with a different well of the donor plate and/or receiver plate. The transfer adapter may seal against the donor plate and/or receiver plate in such a way that the fluid leaving a donor plate well may flow out through an opening, but not into another well of the donor plate, and/or that the fluid entering a receiver plate well may flow in through the opening, but not into another well of the receiver plate. One or more features of the transfer adapter may facilitate the alignment of the openings with the wells and/or the sealing of the plates. For example, each opening may have an associated extension that protrudes from the transfer adapter surface and fits into a well of the donor plate. The transfer adapter may also comprise one or more features to facilitate alignment with and/or sealing against the receiver plate.

Fluid transferred from the wells of the donor plate may flow through the openings in the transfer adapter and into a receiver plate. In some embodiments, the receiver plate may allow mixing of the fluid transferred from each well, such as by containing all of the fluid in one fluidly connected area (e.g., a single large well). In other embodiments, the receiver plate may be configured to prevent mixing of fluid transferred from the donor plate, and the fluid transferred from each well may be contained in a separate area of the receiver plate. For example, the receiver plate may comprise a plurality of receiver wells, and the receiver wells may align with and seal against the openings of the transfer adapter. This may be especially useful if studies are to be performed on the transferred fluid.

The methods described here may comprise forming a transfer assembly and centrifuging the transfer assembly. The transfer assembly may be formed by coupling the donor plate, transfer adapter, and receiver plate in an orientation where the transfer adapter is above the donor plate and below the receiver plate. This coupling may involve aligning the openings of the transfer adapter with the wells of the donor plate and sealing the donor plate and transfer adapter together. Similarly, in embodiments of receiver plates comprising a plurality of receiver wells, coupling the receiver plate and the transfer adapter may comprise aligning the openings and the receiver wells and sealing the receiver plate and transfer adapter together. The transfer assembly may then be repositioned and centrifuged around an axis of rotation. When the transfer assembly is centrifuged, it may be oriented such that the donor plate is closer to the axis of rotation than the transfer adapter and receiver plate. The transfer assembly may be centrifuged at a desired speed and for a desired duration to transfer substantially all of the fluid from the wells of the donor plate to the receiver plate while leaving the target agents attached to the wells. The plates of the transfer assembly may then be separated, and the isolated target agents and/or transferred fluid may be accessed.

Throughout the present disclosure, reference is made to fluid transfer or liquid transfer for the purpose of illustration. It is to be understood that the present transfer system and method may be used for transferring one or more agents in any suitable form, such as but not limited to a liquid, a solution, a gel (e.g., a polymerized gel), a powder (e.g., a dry powder such as a lyophilized powder), a paste, a crystal, or a solid. The target agent may be delivered within any suitable composition, such as but not limited to a liquid or a solution (e.g., when the target agent is a cell type, the cells may be delivered within a cell suspension), a gel (e.g., a hydrogel or sol-gel), a powder, a solid, or the like. Thus, useful material transfer devices and methods of use are disclosed herein.

### Material Transfer System

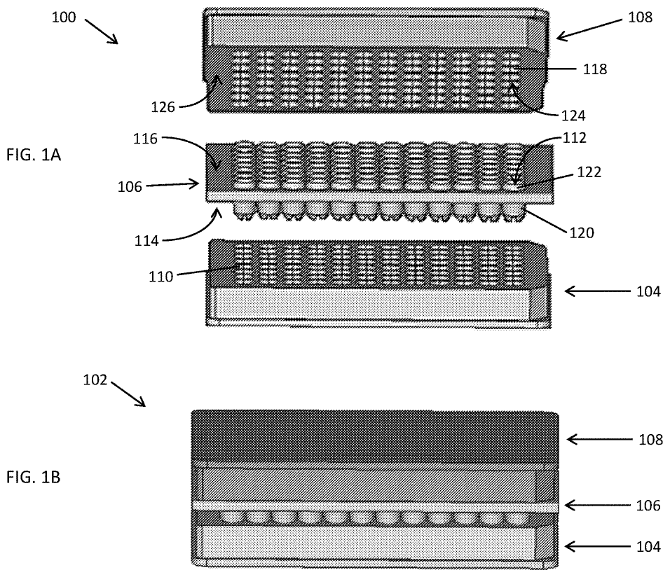

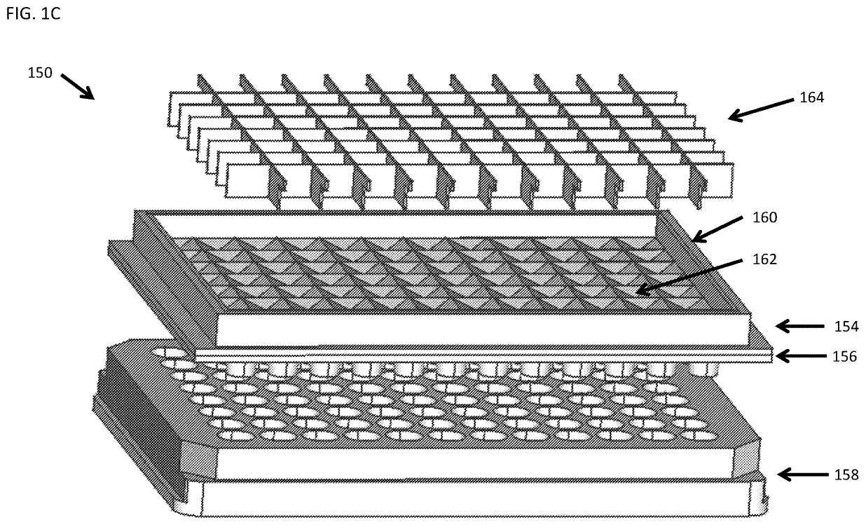

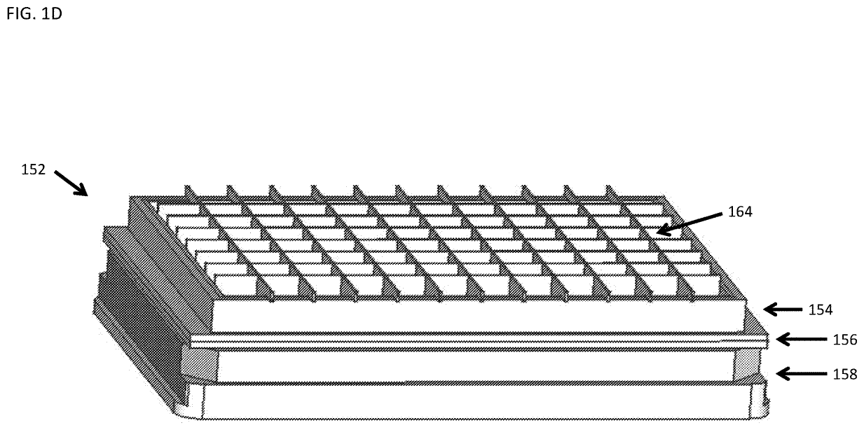

In one aspect, disclosed herein is a material (e.g., fluid) transfer system that facilitates the simultaneous transfer of material (e.g., fluid) to and/or from the wells of a multi-well container (e.g., a plate), for example, by using gravity and/or a centrifugal force (e.g., one generated by a centrifuge). In one aspect, the configuration of a transfer system at least partially determines the flow path of a fluid being transferred to and/or from the wells of a container. In another aspect, the configuration of a transfer system at least partially determines the magnitude of force required to generate a substantial flow of fluid between at least two containers. In order to regulate the transfer of fluid, the multi-well container (e.g., plate) may be reversibly coupled to at least one other container, such as another multi-well container (e.g., plate), as a receiver container. For example, FIG. 1A shows a transfer system 100 that comprises a donor plate 104, a transfer adapter 106, and a receiver plate 108, which may be reversibly coupled to form a transfer assembly 102, shown in FIG. 1B.

In one aspect, the donor container (e.g., plate) comprises a plurality of wells, at least some of which comprise one or more target agents. For example, as shown in FIG. 1A, donor plate 104 is a multi-well plate comprising a plurality of wells 110, at least some of which may comprise one or more target agents and/or be at least partially filled with a fluid. In one aspect, wells 110 containing at least one target agent may be at least partially filled with a fluid, and the systems and methods described herein are configured to assist in transfer of the fluid to isolate the at least one target agent and/or the fluid. In one aspect, transfer adapter 106 comprises a plurality of transfer lumens 112, which may extend from a first side 114 to a second side 116 of the transfer adapter. In one aspect, receiver plate 108 comprises a plurality of receiver wells 118, as shown in FIG. 1A. In one aspect, the receiver plate may have the same structure as the donor plate, but the receiver wells may be empty (e.g., they may not contain a target agent or fluid) when the transfer assembly is initially formed. In some embodiments, the three components of the transfer assembly (e.g., 104, 106, and 108) are configured such that when the transfer assembly (e.g., 102) is formed, each well of the donor container (e.g., plate) may align with a different transfer lumen (e.g., 112) of the transfer adapter and a different receiver well (e.g., 118) of the receiver container (e.g., plate). In some embodiments, the transfer assembly is inverted to a position where the donor container is above the transfer adapter and the receiver container. For example when donor plate 104 is above transfer adapter 106 and receiver container 108, fluid may flow from wells 110, through transfer lumens 112, and into receiver wells 118.

Alternatively, the receiver container (e.g., plate) may comprise a plurality of wells, at least some of which comprise one or more target agents. For example, receiver plate 108 may be a multi-well plate comprising a plurality of wells 118, at least some of which may comprise at least one target agent. In one aspect, the systems and methods described herein are configured to assist in transfer of a fluid to the receiver wells. In one aspect, transfer adapter 106 comprises a plurality of transfer lumens 112, which may extend from a first side 114 to a second side 116 of the transfer adapter. In one aspect, donor plate 104 comprises a plurality of donor wells 110. As shown in FIG. 1A, the receiver plate may have the same structure as donor plate 104, but the receiver wells do not contain fluid when transfer assembly 102 is initially formed. In some embodiments, the three components of the transfer assembly (e.g., 104, 106, and 108) are configured such that when the transfer assembly (e.g., 102) is formed, each well of the donor container (e.g., plate) may align with a different transfer lumen (e.g., 112) of the transfer adapter and a different receiver well (e.g., 118) of the receiver container (e.g., plate). In some embodiments, the transfer assembly is inverted to a position where the donor container is above the transfer adapter and the receiver container. For example when donor plate 104 is above transfer adapter 106 and receiver container 108, fluid may flow from wells 110, through transfer lumens 112, and into receiver wells 118 (e.g., in order to contact and/or react with the one or more target agents in one or more receive wells).

In one aspect, a donor container is configured to removably and/or sealingly couple with a first side of a transfer adapter, and a receiver plate is configured to removably and/or sealingly couple with a second side of the transfer adapter. For example, as shown in FIG. 1A, donor plate 104 is configured to removably couple with first side 114 of transfer adapter 106, and receiver plate 108 is configured to removably couple with second side 116 of the transfer adapter. In one aspect, in addition to aligning wells 110, transfer lumens 112, and receiver wells 118, coupling of the three components (e.g., 104, 106, and 108) seals the donor wells against the first side of the transfer adapter, and seals the receiver wells against the second side of the transfer adapter. In some embodiments, the seals are configured to prevent, minimize, or reduce mixing of contents (e.g., mixing of fluid) between the donor wells or between the receiver wells. For example, the seal of the donor wells against the first side of the transfer adapter may prevent, minimize, or reduce mixing among the donor wells, such as mixing between two adjacent donor wells. Similarly, the seal of the receiver wells against the second side of the transfer adapter may prevent, minimize, or reduce mixing among the receiver wells, such as mixing between two adjacent receiver wells. When the donor container, the transfer adaptor, and the receiver container are aligned, the seals allow transfer of a content between a donor well and its corresponding receiver well (and no other receiver well), while preventing, minimizing, or reducing mixing between the donor well and other receiver wells.

In some embodiments, the donor plate, the transfer adapter, and/or the receiver plate comprise one or more features configured to facilitate alignment of structures (e.g., donor wells, transfer lumens, and receiver wells) of the plates, coupling of the components, and/or sealing of the components. For example, transfer adapter 106 shown in FIG. 1A may comprise primary extensions 120 configured to be inserted into donor wells 110 of donor plate 104, and secondary extensions 122 configured to be inserted into receiver wells 118 of receiver plate 108. Insertion of the primary and secondary extensions into the donor wells and receiver wells, respectively, may facilitate alignment and/or sealing.

In some embodiments, the receiver plate and the donor plate may have different structures. In one aspect, a donor plate comprises a boundary wall, a directing well structure, and optionally a separation well structure. For example, in transfer system 150 as shown in FIG. 1C, donor plate 154 comprises boundary wall 160, directing well structure 162, and separation well structure 164, while receiver plate 158 is a multi-well plate. In some embodiments, the donor plate is fixedly attached or integral to the transfer adapter (e.g., 156 in FIG. 1C). In some embodiments, the donor plate comprises a separation well structure coupled thereto. In some embodiments, the separation well structure is configured to be removably coupled to the donor plate, and assembling the transfer assembly further comprises coupling the separation well structure to the donor plate. In some embodiments, the separation well structure is fixedly attached or integral to the donor plate.

Referring to the transfer assembly 152 as shown in FIG. 1D, the transfer assembly may be assembled in a first position, with transfer adapter 156 positioned below donor plate 154 and above receiver plate 158. In one aspect, donor plate 154 is in an upright position, with the top openings of the wells facing upwards and the bottom openings of the wells (not shown) facing downwards and toward transfer adapter 156. In another aspect, receiver plate 158 is in an upright position, with the inlets of the receiver wells facing upwards toward transfer adapter 156. In this position the fluid may remain in the wells of the donor plate due to the properties of the transfer adapter and/or the fluid, and may be transferred to the receiver wells due to gravity and/or a centrifugal force (e.g., one generated by a centrifuge). As shown in FIG. 1D, separation well structure 164 may be used in conjunction with the boundary wall and the directing well structure to form individual donor wells.

### Donor Plate

A variety of donor plates may be suitable for use in the transfer systems and assemblies described herein. However, regardless of the specific type of donor plate, one of its functions may be to contain one or more fluids and optionally one or more target agents in one or more individual wells. In some embodiments, the donor plate may be a multi-well plate, also known as a microtiter or microwell plate. In particular embodiments, the donor plate may be a standard, off-the-shelf multi-well plate, such as those commonly used for a wide range of laboratory applications. In other embodiments, the donor plate may comprise one or more custom features, such as those that facilitate the transfer of fluid and/or the interaction between the donor plate and the transfer adapter. While the characteristics of the donor plate may vary (e.g., the number of wells, the size of the wells, and the contents of the wells etc.), any multi-well plate that may be placed in a centrifuge is suitable for use with the transfer systems described herein.

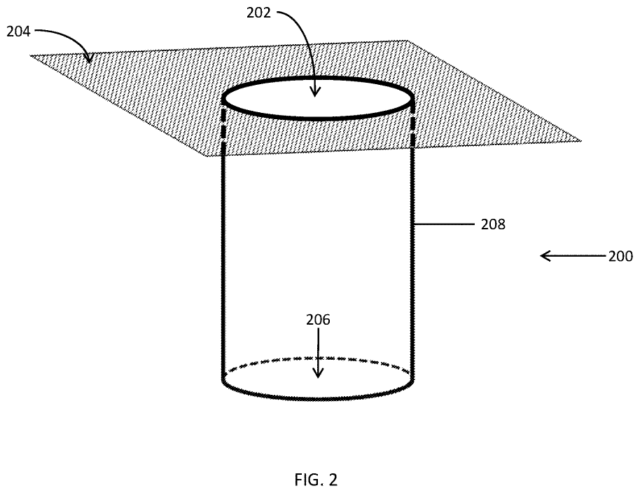

In one aspect, a donor container and/or receiver container described herein may be a multi-well plate. A multi-well plate may comprise a grid of small, open divots or wells which may contain an agent or substance of interest. FIG. 2 illustrates a representative well (200) of a multi-well plate. In some embodiments, the well (e.g., 200) may comprise an opening (e.g., 202) through a top surface (e.g., 204) of the multi-well well plate, and material may enter and/or exit the well through the opening. In some embodiments, the well may comprise and be bounded by a base (e.g., 206) and one or more sides or walls (e.g., 208). In some embodiments, the cross-sectional shape of the well is circular, for example as shown in FIG. 2. It should be appreciated that a well may have any suitable cross-sectional shape, e.g., a cross-section that is a triangle, rectangle, any other quadrilateral, pentagon, hexagon, circle, ellipse, oval, any other rounded shape, or irregular shape. In some embodiments, the one or more walls (e.g., 208) of the well (e.g., 200) are perpendicular to the top surface (e.g., 204) of the multi-well plate, and/or parallel to a longitudinal axis of the well, for example as shown in FIG. 2. In other embodiments, the one or more walls may be angled relative to a longitudinal axis of the well. In some embodiments, a cross-sectional shape and/or area of the opening (e.g., 202) may be different than the cross-sectional shape and/or area of the base (e.g., 206). In some embodiments, the base comprises a flat surface, or comprises a concave, a convex, or a surface of any other suitable shape.

In one embodiments, the donor container and/or the receiver container may have any suitable number of wells, e.g., at least one well, or at least two wells in the case of a multi-well plate. For example, off-the-shelf multi-well plates may comprise at least about 6 wells, at least about 12 wells, at least about 24 wells, at least about 48 wells, at least about 96 wells, at least about 384 wells, at least about 480 wells, at least about 1536 wells, at least about 3456 wells, or more than 3456 wells. The wells may have any suitable arrangement, such as in rows and columns, and in some embodiments, the distance between every pair of adjacent wells may be approximately the same. In some embodiments, the multi-well plate may comprise one or more features that may allow the wells to be separated and/or combined. For example, in some embodiments, the walls of the wells may be removable and/or repositionable to change the number, shape, and/or size of the wells, for example, as described in more detail in International Patent Application Ser. No. PCT/US15/16435, entitled “Multi-well separation apparatus and reagent delivery device” and filed on Feb. 18, 2015, the content of which is hereby incorporated by reference herein in its entirety.

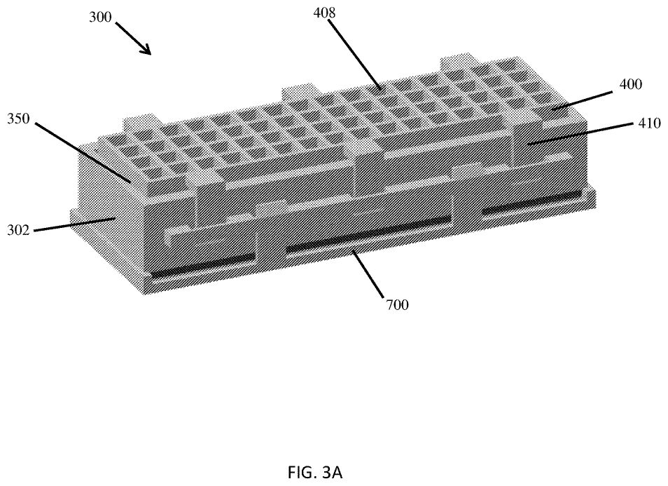

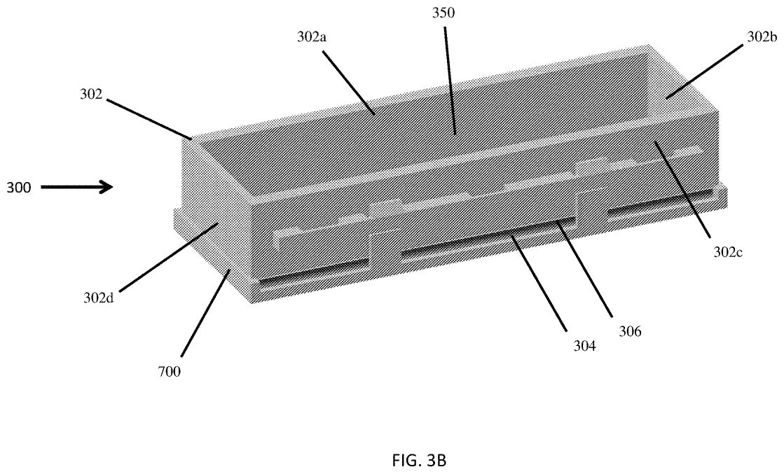

In some embodiments, the donor plate comprises a boundary wall forming the lateral portions of a holding cavity. For example as shown in FIG. 3A, donor plate 300 comprises boundary wall 302, which forms the lateral portions enclosing holding cavity 350. In the examples shown in FIGS. 3A and 3B, boundary wall 302 comprises four orthogonal portions—a first portion 302a, a second portion 302b, a third portion 302c, and a fourth portion 302d. These four portions may define a rectangular region. In some embodiments, the four orthogonal portions may be one integrated component, while in other embodiments, the four orthogonal portions may comprise more than one component (e.g., two, three, four, or more), which may be attached or assembled in any suitable manner, e.g., using an adhesive (such as a glue, an adhesive polymer, or the like), welding, a mechanical fastener, chemical bonding, or the like, in any suitable combination.

It should be appreciated, however, that the boundary wall need not define a rectangular region, and furthermore, it need not comprise four portions. In some embodiments, for example, the boundary wall may define any polygon, e.g., a triangle, a quadrilateral (e.g., a parallelogram or a trapezoid), a pentagon, a hexagon, etc. It should be appreciated that the boundary wall need not be substantially planar and may be curved to define a region having a curved shape, e.g., a circle, ellipse, oval, annulus, circular segment, etc. In some embodiments, the boundary wall comprises fewer than four portions (e.g., one, two, or three portions) or more than four portions (e.g., five, six, seven, eight, or more portions). In other embodiments, the boundary wall defines more than one region. For example, in some embodiments the boundary wall may comprise a fifth portion, which may be attached to opposite portions of the boundary wall, e.g., on a first end to the first portion 302a and on a second end to the third portion 302c. In such embodiments, the boundary wall may define two rectangular regions.

In some embodiments, the donor plate further comprises a boundary seal. For example as shown in FIG. 3A, donor plate 300 comprise boundary seal 304. In one aspect, the boundary seal is configured to form a leak-proof seal between the boundary wall and the transfer adapter. For example, when boundary wall 302 and transfer adapter 700 are coupled as shown in FIGS. 3A and 3B, the boundary seal can form a leak-proof seal between the boundary wall and the transfer adapter. The boundary seal may comprise any suitable material for forming a seal, such as but not limited to a rubber, a plastic, a polymer, or any combination thereof. In some embodiments, the boundary seal comprise the suitable material having a shape corresponding to a distal side of the boundary wall. For example, as shown in FIG. 3B, boundary seal 304 may comprise a thin strip of the suitable material having a shape corresponding to distal side 306 of boundary wall 302.

In some embodiments, the boundary seal is configured to be located between the boundary wall and the transfer adapter, when the boundary wall and the transfer adapter are coupled. In some embodiments, the boundary seal is fixed to a distal side of the boundary wall. In these embodiments, the boundary seal may be fixed to the distal side (e.g., 306 as shown in FIG. 3B) in any suitable manner, such as but not limited to, using an adhesive (such as a glue, an adhesive polymer, or the like), welding, a mechanical fastener, chemical bonding, or the like, in any suitable combination. In some embodiments, the fixation of the boundary seal to the distal side of the boundary wall creates a leak-proof seal between the boundary seal and the boundary wall, while a compressive force between the boundary wall and the transfer adapter may press together the boundary seal and the transfer adapter, thereby creating a leak-proof seal as well between the boundary seal and the transfer adapter.

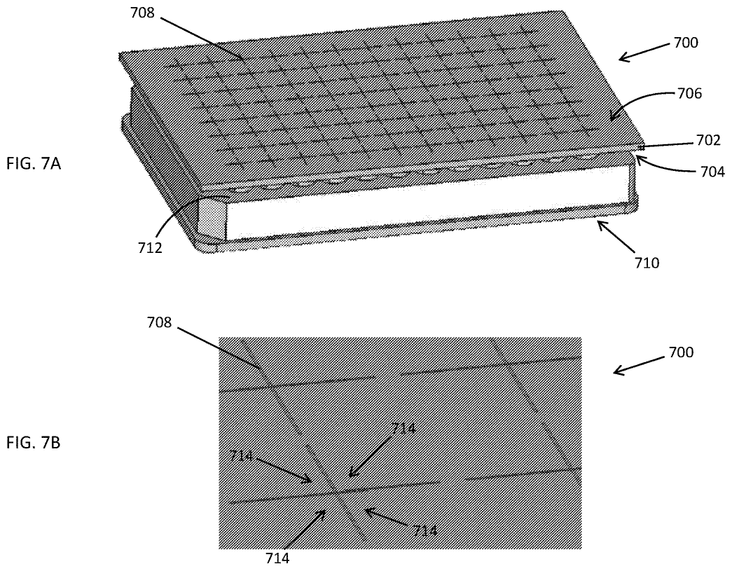

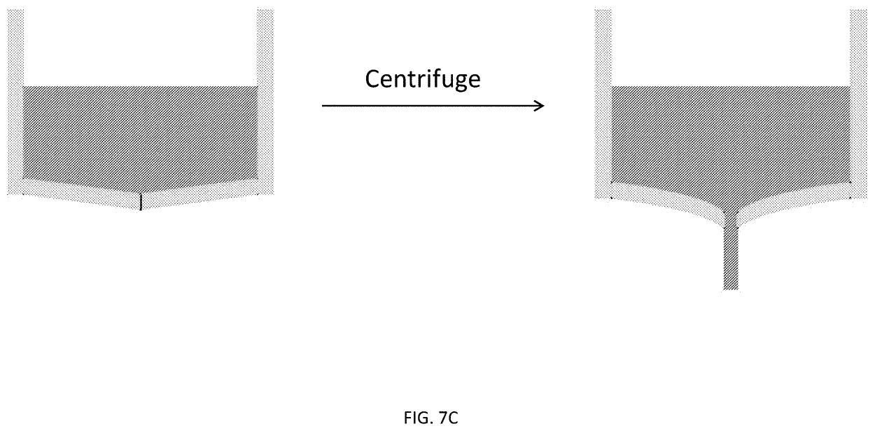

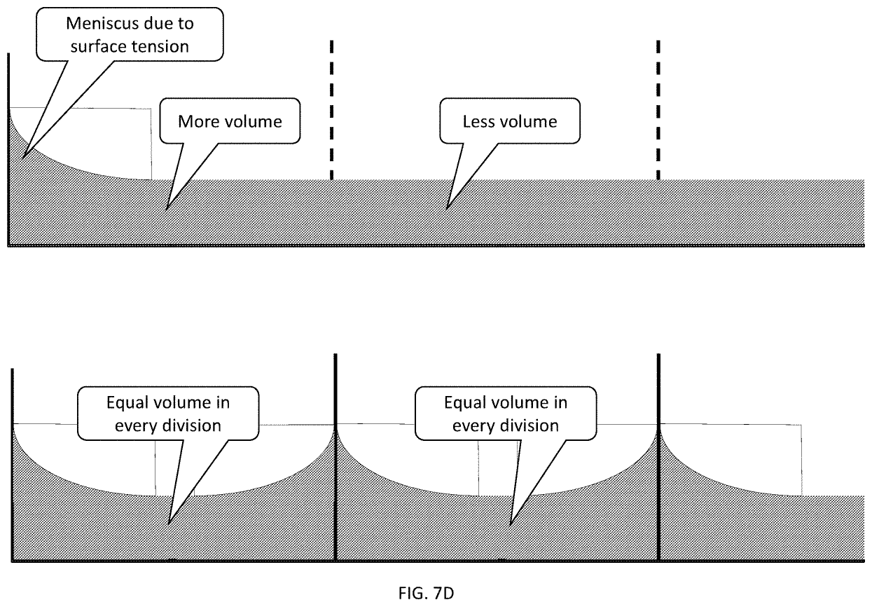

In other embodiments, the boundary seal is fixed to a first planar surface of the transfer adapter, again in any suitable manner, such as by using an adhesive (such as a glue, an adhesive polymer, or the like), welding, a mechanical fastener, chemical bonding, or the like, in any suitable combination. In one aspect, the fixation of the boundary seal to the first planar surface (e.g., 704 as shown in FIG. 7A) of the transfer adapter creates a leak-proof seal between the boundary seal and the transfer adapter, while a compressive force between the boundary wall and the transfer adapter presses together the boundary wall and the boundary seal, thereby creating a leak-proof seal between the boundary wall and the boundary seal as well.

In yet other embodiments, the boundary seal is not fixed to either the boundary wall or the transfer adapter, but instead is sandwiched between the boundary wall and the transfer adapter by a compressive force when the boundary wall and the transfer adapter are coupled. In still other embodiments in which the boundary wall is fixedly attached to the transfer adapter, the boundary seal is fixed to both a first planar surface of the transfer adapter and a distal side of the boundary wall.

It should be appreciated, however, that the donor plates described herein need not comprise a boundary seal. For example, a boundary seal may be unnecessary if the boundary wall and substrate are configured to form a holding cavity that can suitably hold a composition (e.g., a cell suspension) within it without leaking, without a boundary seal. For example, in embodiments in which the boundary wall is fixedly attached or integral to the transfer adapter, the donor plate may not comprise a boundary seal. As another example, in embodiments in which the boundary wall and transfer adapter are not fixedly attached or integral but are configured to form a leak-proof seal, the donor plate may not comprise a boundary seal. This may be the case, for instance, if the boundary wall comprises a material such as a rubber, a plastic, or a polymer (e.g., an elastic polymer) that is configured to sealing or fittingly engage a structure or material (e.g., a rubber, a plastic, or a polymer) of the transfer adapter. In these cases, compressive force pressing together the boundary wall and the transfer adapter may create a leak-proof seal directly (e.g., without a boundary seal structure) between the boundary wall and the transfer adapter.

Returning to the embodiments of donor plate 300 of FIGS. 3A and 3B, the transfer adapter and boundary wall 302 may form a holding cavity 350 when coupled. In some embodiments, the holding cavity provides a region configured to hold a fluid, such as an aqueous composition, or the like. It should be appreciated that a similar holding cavity may be formed by the boundary wall and transfer adapter in embodiments in which the boundary wall is fixedly attached or integral to the transfer adapter.

While FIGS. 3A and 3B show the coupled boundary wall 302 and transfer adapter 700 as forming a single integrated holding cavity 350, in other embodiments, the coupled boundary wall and transfer adapter may form a holding cavity having more than one region. For example, in the embodiments mentioned above in which the boundary wall comprises a fifth portion, which may be attached to opposite portions of the boundary wall (e.g., on a first end to first portion 302a and on a second end to the third portion 302c), the holding cavity may comprise two rectangular regions. These two regions may be separated by the boundary wall, such that composition located in one region will not be able to travel to the other region.

The holding cavity, and in turn the components forming it, may have any suitable dimensions. In some embodiments, the donor plate (e.g., 300 as shown in FIGS. 3A and 3B) is configured to approximate a standard 96-well plate. Thus, the length and width of transfer adapter 700 and boundary wall 302 may be less than about 13 cm in its largest dimension, or about 130 mm by 85 mm. The depth of the holding cavity 350 (and thus the approximate height of the boundary wall 302) may in some embodiments be about 1 mm, about 3 mm, about 5 mm, about 7 mm, about 9 mm, about 11 mm, about 13 mm, about 15 mm, about 17 mm, about 19 mm, about 25 mm, about 30 mm, about 35 mm, about 40 mm, or more than about 40 mm.

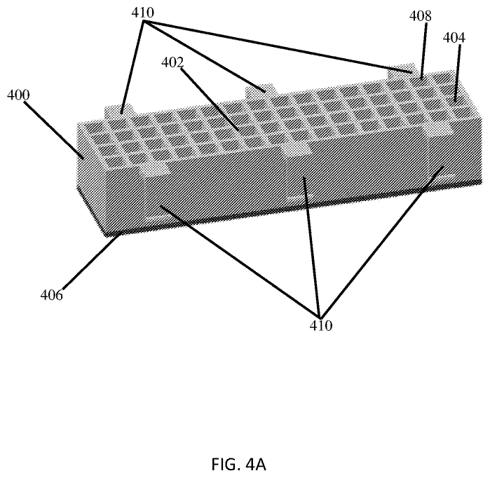

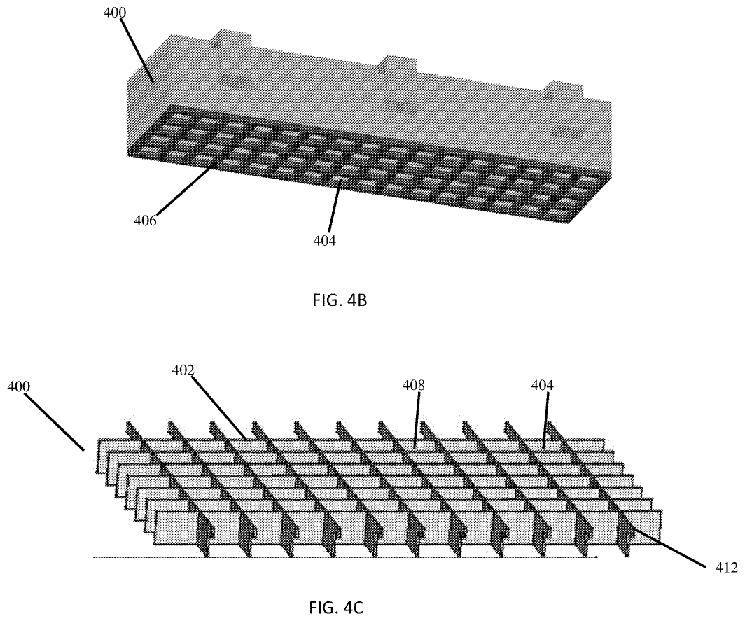

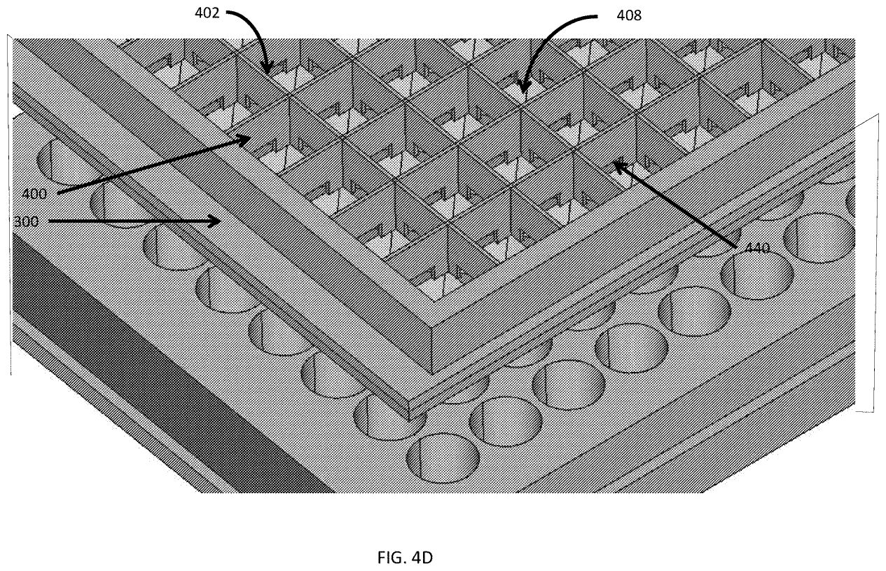

In one aspect, provided herein is a separation well structure configured to be placed within a holding cavity of a donor plate. In some embodiments, the donor plate comprises a separation well structure removably placed or irreversibly disposed within the holding cavity. FIG. 4A illustrates a separation well structure 400 configured to be located within a holding cavity. Donor plate 300 in FIG. 3B may comprise separation well structure 400 that may be placed within its holding cavity 350. In some embodiments, the separation well structure is configured to be removably coupled within the holding cavity. In some embodiments, the separation well structure is fixedly attached or integral to the boundary walls (e.g., 302) and/or transfer adapter (e.g., 700). When the separation well structure is placed within the holding cavity of a donor plate, it may divide a fluid (e.g., an aqueous composition) in the holding cavity into separated volumes/regions. This manner of dividing a composition into separated volumes/regions may be simpler and/or more efficient than traditional manners, such as individually pipetting a volume of liquid into separate wells, which may require repeated transfer of compositions, as opposed to one-time transfer of the compositions into the holding cavity. Once a material is divided into separated volumes/regions, this may allow the separated volumes/regions to be subject to different processes (e.g., by introducing a different reagent into each volume/region). Furthermore, the separation well structure may also be removed from the holding cavity, allowing the contents of the separated volumes/regions to be modified in bulk. When it is desirable to perform the same process for each of the separated volumes/regions (e.g., a washing step), this may be simpler and more efficient than performing the process individually for each of the separated volumes/regions.

As shown in FIG. 4A, separation well structure 400 may comprise a plurality of separation walls 402. In some embodiments, separation walls 402 may comprise two orthogonal sets of parallel walls and may form a grid- or lattice-like structure, such that they form an array or matrix of openings 404 separated by separation walls 402. When the separation well structure is coupled within the holding cavity, it may separate the holding cavity into a plurality of separation wells, such as separation wells 408 shown in FIG. 4A. In some embodiments, when separation well structure 400 as shown in FIG. 4C is placed into the holding cavity, boundary wall 302 forms at least part of the outer walls of the outermost separation wells 408, as shown in FIG. 4A. In other embodiments, separation well structure 400 as shown in FIG. 4C may have its own outer walls, such that when the separation well structure is placed into the holding cavity, the boundary wall is not required to form the outer walls of the outermost separation wells.

In some embodiments, the separation well structure further comprises one or more separation seals, such as 406 shown in FIG. 4B. In the embodiment shown in FIG. 4C, separation well structure 400 may comprise one or more separation well lips 412 configured to couple to the top edge of boundary wall 302. In some embodiments, the donor plate with the separation walls is configured to approximate a standard 96-well plate. For example, in FIG. 4C (and FIGS. 1C and 1D), the separation walls when placed in the holding cavity create 96 openings (i.e., 8 rows×12 columns).

In some embodiments, the separation walls comprise one or more separation wall slots configured to fluidly connect at least two (such as all) of the separation wells. In some embodiments, as shown in FIG. 4D, separation walls 402 may comprise one or more separation wall slots 440 such that some or all of separation wells 408 can be fluidly connected. In one aspect, separation walls 402 may comprise a separation wall slot (e.g., 440) between every pair of adjacent separation wells 408. In another aspect, at least part of the separation walls may not contact the transfer adapter, leaving one or more gaps between the transfer adapter and the bottom surface of the separation walls, thus fluidly connecting some or all of the separation wells. In some embodiments, the size of the gap between the transfer adapter and the bottom surface of the separation walls may be smaller than the height of the fluid in the holding cavity, such that the separation walls are at least partially submerged in the fluid when the separation well structure is coupled within the holding cavity. In one aspect, separation walls 402 and optionally boundary wall 302 may form the lateral walls of separation wells 408, while the transfer adapter may form the base of the separation wells. In another aspect, the contents of holding cavity 350 may be separated and divided into separation wells 408. The separation well structure may comprise any suitable material or materials, such as but not limited to a rubber, plastic, silicon, ceramic, metal, polymer, glass, or the like, or in any suitable combination thereof.

In some embodiments, when the separation walls are coupled within the holding cavity, the separation walls have approximately the same height as the boundary wall. For example, both the separation walls and the boundary wall can be about 1 mm, about 3 mm, about 5 mm, about 7 mm, about 9 mm, about 11 mm, about 13 mm, about 15 mm, about 17 mm, about 19 mm, about 25 mm, about 30 mm, about 35 mm, about 40 mm, or more, in height. In some embodiments, the separation walls have a lower height than the boundary wall, so long as the height of the separation walls (and thus the depth of the separation wells) is greater than the depth of the fluid within the holding cavity when the separation walls are coupled within the cavity, in order to prevent contents from flowing between separation wells over the separation walls. In other embodiments, the separation walls have a greater height than the boundary wall, so long as the height of the separation walls (and optionally the height of the boundary wall) is greater than the depth of the fluid within the holding cavity when the separation walls are coupled within the cavity. It should be noted that no all of the openings of the separation walls need be used for material transfer.

In some embodiments, the separation well structure substantially fills the holding cavity. For example, the cross-sectional dimensions of separation well structure 400 can be substantially the same as the cross-sectional dimensions of holding cavity 350. In one aspect, holding cavity 350 is configured to fittingly accommodate separation well structure 400. In other embodiments, the separation well structure need not fill the holding cavity. For example, separation well structure 400 may have a smaller cross-sectional area than holding cavity 350, and may thus only subdivide a portion of holding cavity 350 into separation wells 408.

In some embodiments, one or more of the separation walls comprise one or more separation wall slots. In one aspect, the separation wall slot comprises an opening in a separation wall. In another aspect, the separation wall slot is positioned at the bottom of a separation wall. In a further aspect, the separation wall slot comprises a gap in the bottom edge of the separation wall. For example as shown in FIG. 4D, one or more separation walls 402 comprise one or more separation wall slots 440, such as an opening in a separation wall. In some embodiments, separation wall slot 440 is positioned at the bottom of a separation wall and may comprise a gap in the bottom edge of separation wall 402. It should be appreciated that separation wall slot 440 may be positioned anywhere along separation wall 402, such as in the interior of separation wall 402 and bounded on all sides by the separation wall, or at the top of the separation wall and being a gap in the top edge of the separation wall. In some embodiments, separation wall slot 440 may extend beyond an intersecting separation wall 402. In other embodiments, separation wall slot 440 may not extend beyond an intersecting separation wall 402. In some embodiments, separation wall slot 440 may extend beyond one or more intersecting separation walls 402. In other embodiments, separation wall slot 440 may not extend beyond one or more intersecting separation walls 402. In some embodiments, separation wall slot 440 may extend along the entire length of separation wall 402. In other embodiments, separation wall slot 440 may not extend along the entire length of separation wall 402.

In some embodiments, one or more of the separation walls comprise one or more separation wall slots configured to divide the holding cavity into subsets of separation wells that are configured to be fluidly connected with other separation wells in the subset but not configured to be fluidly connected to separation wells in other subsets. For example, in some embodiments, a first separation wall 402 that bisects the holding cavity does not comprise any separation wall slots 440, and the remaining separation walls 402 comprise separation wall slots 440 between each adjacent separation well 408, resulting in a first subset of separation wells 408 on one side of the first separation wall that are configured to fluidly connect with each other and a second subset of separation wells 408 on the other side of the first separation wall that are configured to fluidly connect with each other, whereas the first subset of separation wells are not configured to fluidly connect with the second subset of separation wells. In some embodiments, the separation wells may be subdivided into any number and/or configuration of separation well subsets that are configured to fluidly connect only to other separation wells in the same subset.

In some embodiments, the separation wall slots may have a cross-sectional area of any suitable shape and/or dimension. In some embodiments, the largest dimension of the cross section of the separation wall slot may be about 1 μm to about 20 μm, about 20 μm to about 40 μm, about 40 μm to about 60 μm, about 60 μm to about 80 μm, about 80 μm to about 100 μm, about 100 μm to about 200 μm, about 200 μm to about 400 μm, about 400 μm to about 600 μm, about 600 μm to about 800 μm, about 800 μm to about 1 mm, about 1 mm to about 2 mm, about 2 mm to about 4 mm, about 4 mm to about 6 mm, about 6 mm to about 8 mm, about 8 mm to about 1 cm, greater than about 1 cm, about 1 μm to about 1 cm, about 100 μm to about 1 mm, or about 1 mm to about 1 cm. However, it should be recognized that in some embodiments, it may be desirable for the cross-sectional area of the separation wall slots to be of a particular value in order to allow for the fluid within the holding cavity to freely flow across the separation wall slots (e.g., 440) and between separation wells (e.g., 408).

In one aspect, the separation wall slots may have any suitable shape, such as but not limited to a cross-section having the shape of a triangle, square, rectangle, any other quadrilateral (parallelogram or trapezoid, etc.), pentagon, hexagon, etc., any rounded shape (circle, ellipse, or oval, etc.), or an irregular shape. In some embodiments, one or more of the separation wall slots have a rectangular cross-sectional shape, for instance as shown in FIG. 4D. In some embodiments, one or more or all of the separation wall slots have equal cross-sectional sizes and/or shapes. In some embodiments, the separation wall slots need not have the same size and/or shape.

In one aspect, the openings (e.g., 404) may have any suitable cross-sectional area. In some embodiments, the largest dimension of the cross section of the openings may be about 1 μm to about 20 μm, about 20 μm to about 40 μm, about 40 μm to about 60 μm, about 60 μm to about 80 μm, about 80 μm to about 100 μm, about 100 μm to about 200 μm, about 200 μm to about 400 μm, about 400 μm to about 600 μm, about 600 μm to about 800 μm, about 800 μm to about 1 mm, about 1 mm to about 2 mm, about 2 mm to about 4 mm, about 4 mm to about 6 mm, about 6 mm to about 8 mm, about 8 mm to about 1 cm, greater than about 1 cm, about 1 μm to about 1 cm, about 100 μm to about 1 mm, or about 1 mm to about 1 cm. However, it should be recognized that in some embodiments, it is desirable for the ratio between the height and cross-sectional area of the openings (e.g., 404) to be of a particular value in order to counter a capillary effect. The resulting separation wells (e.g., 408) may have any suitable volume, such as but not limited to less than about 100 μL, about 100 μL to about 200 μL, about 200 μL to about 400 μL, about 400 μL to about 600 μL, about 600 μL to about 800 μL, about 800 μL to about 1 mL, about 1 mL to about 10 mL, about 10 mL to about 20 mL, about 20 mL to about 40 mL, about 40 mL to about 60 mL, about 60 mL to about 80 mL, about 80 mL to about 100 mL, more than about 100 mL, about 100 μL to about 100 mL, or about 1 mL to about 10 mL.

While the openings (e.g., 404) are shown in FIGS. 4A-4C as having a square cross-sectional shape, the openings may have any suitable shape, such as but not limited to a cross-section having the shape of a triangle, rectangle, any other quadrilateral (parallelogram or trapezoid, etc.), pentagon, hexagon, etc., any rounded shape (circle, ellipse, or oval, etc.), or an irregular shape. In some embodiments, one or more or all of the openings have equal cross-sectional sizes and/or shapes. In some embodiments, the openings need not have the same size and/or shape. In other embodiments, the cross-sections of the openings need not be the same along a dimension of an opening. For example, in some embodiments, the cross-sectional area of each opening at its proximal end (e.g., proximal to a transfer adaptor) may be greater than the cross-sectional area at its distal end (e.g., distal to the transfer adaptor). In other embodiments, the cross-sectional area of each opening at its distal end may be greater than the cross-sectional area at its proximal end. It should be appreciated that in these cases, the thickness of the separation walls (e.g., 402) may correspondingly vary to create the variable cross-sectional area. For example, the thickness of the separation wells may be greater at the distal end (e.g., distal to a transfer adaptor) than the proximal end (e.g., proximal to the transfer adaptor), or alternatively, the thickness may be greater at the proximal end than at the distal end.

In the embodiment shown in FIGS. 4A-4B, separation well structure 400 defines 64 openings 404, and thus when coupled within a holding cavity (e.g., 350), the separation well structure may separate the holding cavity into 64 separation wells 408. It should be appreciated, however, that the separation well structure may define any number of openings, and thus when coupled with a holding cavity (e.g., 350), the separation well structure may separate the holding cavity into any number of separation wells. For example, the separation well structure may define at least about 6, at least about 12, at least about 24, at least about 48, at least about 96, at least about 384, at least about 480, at least about 1536, at least about 3456, or more openings, and thus when coupled with a holding cavity (e.g., 350) may separate the holding cavity into at least about 6, at least about 12, at least about 24, at least about 48, at least about 96, at least about 384, at least about 480, at least about 1536, at least about 3456, or more separation wells. It should be understood that the number of openings (e.g., 404) and the separation wells (e.g., 408) need not be limited by the numbers listed here. While in some embodiments the separation well structure may define numbers of openings found in standard microtiter laboratory plates, in other embodiments the separation well structure may define non-standard numbers of openings, which may or may not be rectangular numbers.

It some embodiments, it is desirable to maximize the number of separation wells (e.g., 408) within a given cross-sectional area, e.g., the cross-sectional area of holding cavity 350. In order to do so, it may be desirable to minimize the thickness of the separation walls (e.g., 402). In some embodiments, the thickness of the separation walls may be about 50 μm to about 2000 μm. In particular embodiments, the thickness of the separation walls is about 200 μm to about 1800 μm, about 400 μm to about 1600 μm, about 600 μm to about 1400 μm, about 800 μm to about 1400 μm, or about 1000 μm to about 1200 μm.

It should also be appreciated that in some embodiments, the boundary wall (e.g., 302) described herein may be used without a separation well structure such as 402.

In some embodiments, the separation well structure further comprises a separation seal. In one aspect, when the separation well structure and the transfer adapter are coupled, the separation seal may create a leak-proof seal at the distal end of one or more separation wells. In some embodiments, this may allow each separation well to be an isolated region, such that it may undergo processes or treatments distinct from its neighboring separation well or wells. As shown in FIGS. 4A-4B, separation seal 406 may be located between the distal surfaces of separation walls 402 of separation well structure 400 and a first planar surface (e.g., 704) of the transfer adapter, when the separation well structure and the transfer adapter are coupled. In some embodiments, the separation seal may cover the bottom edge of at least one or every separation well and may thus provide sealing for the at least one or every separation well when pressed onto the transfer adapter. The separation seal may comprise any suitable material for forming a seal, such as but not limited to a rubber, a plastic, or a polymer, or any suitable combination thereof.

In the embodiments shown in FIGS. 4A-4B, separation seal 406 is coupled to the distal surfaces of separation walls 402 of separation well structure 400. The separation seal may be attached to the separation well structure in any suitable manner, such as but not limited to, by using an adhesive (e.g., a glue, an adhesive polymer, or the like), chemical bonding, or the like, or any combination thereof. However, it should be appreciated that in other embodiments, the separation seal may be attached to the first planar surface (e.g., 704) of the transfer adapter. In yet other embodiments, the separation seal may be attached to the boundary wall (e.g., 302). In some embodiments, the separation seal may be integral to the boundary seal (e.g., 304), or it may be attached to the boundary seal.

It should further be appreciated that the separation well structure (e.g., 400) need not comprise a separation seal (e.g., 406). A separation seal may be unnecessary if the separation well structure and transfer adapter are configured to form separation wells that can suitably hold a fluid (e.g., an aqueous composition) within them without leaking, without a separation seal. For example, this may be the case if the separation seal comprises a material such a rubber, a plastic, or a polymer that may be capable of forming a seal with the material of the transfer adapter. In these cases, a compressive force pressing together the separation well structure and the transfer adapter may create a leak-proof seal directly between the separation well structure and the transfer adapter, without requiring an intermediate separation seal. As another example, the donor plate may not comprise a separation seal in some (but not all) embodiments in which it comprises a directing well structure, as described in more detail below.

In some embodiments, the separation well structure (e.g., 400) may be configured to be coupled within the holding cavity (e.g., 305), such that when coupled, there is sufficient compressive pressure between the separation well structure and the transfer adapter (e.g., 700) that leak-proof separation wells (e.g., 408) are formed. In some embodiments, the separation well structure may be configured to be coupled within the holding cavity via the boundary wall (e.g., 302) and/or the transfer adapter (e.g., 700). In the embodiment shown in FIGS. 4A-4B, separation well structure 400 comprises separation well clips 410 configured to couple to boundary wall 302. In the embodiment shown in FIG. 4C, separation well structure 400 comprises separation well lips 412 configured to couple to a top edge of boundary wall 302.

In some embodiments, the donor plate (e.g., 300) comprises a separation well structure (e.g., 400) configured to removably couple within the holding cavity (e.g., 350). In one aspect, the design of the coupling mechanism between the separation well structure and the holding cavity may be such that the separation well structure can be removed from the holding cavity after the two elements have been coupled. The ability to uncouple and be removed from the holding cavity may allow the separation well structure to be inserted to initially separate the fluid within the holding cavity into separation wells, and then may allow the separation well structure to be removed to recombine fluids in the separation wells.

In some embodiments, the donor plate (e.g., 300) comprises a separation well structure (e.g., 400) fixedly coupled within the holding cavity (e.g., 350). In one aspect, the design of the coupling mechanism between the separation well structure and the holding cavity may be such that the separation well structure cannot be removed from the holding cavity after the two elements have been coupled. In some embodiments, the donor plate (e.g., 300) comprises a separation well structure (e.g., 400) fixedly attached or integral to the boundary wall (e.g., 302) and/or the transfer adapter (e.g., 700).

It should be appreciated that any of the separation well structure features described may be combined in any suitable way. For example, an embodiment of a transfer adapter may comprise some components from the embodiment discussed with respect to FIGS. 4A-4B and other components from the embodiments discussed with respect to FIGS. 4C-4D.

In some embodiments, the donor plate (e.g., 300) comprises a directing well structure (e.g., 502). The directing well structure may be configured to reduce the cross-sectional area of a distal portion of the separation wells (e.g., 408). This may be advantageous, for example, because it may direct the fluid within each separation well into a smaller cross-sectional area at the base of the separation well aligned with an opening in the transfer adapter (e.g., 700). In some embodiments, the directing well structure may comprise a thin layer of material, such as but not limited to a soft and/or elastic material (e.g., silicone, rubber, or the like), which may be configured to be located between the separation well structure and the transfer adapter. Generally, the directing well structure may comprise a plurality of openings, which on the proximal end may correspond to the distal end of the openings of the separation well structure, and the openings may narrow in the proximal to distal direction. The distal ends of the openings in the directing well structure may allow the fluid within the separation wells to be directed to an opening in the transfer adapter. In some embodiments, the centers of the separation wells may not align with the openings in the transfer adapter, and the distal ends of the openings in the directing well structure may be positioned to direct the flow of the fluid in the separation wells to the openings in the transfer adapter.

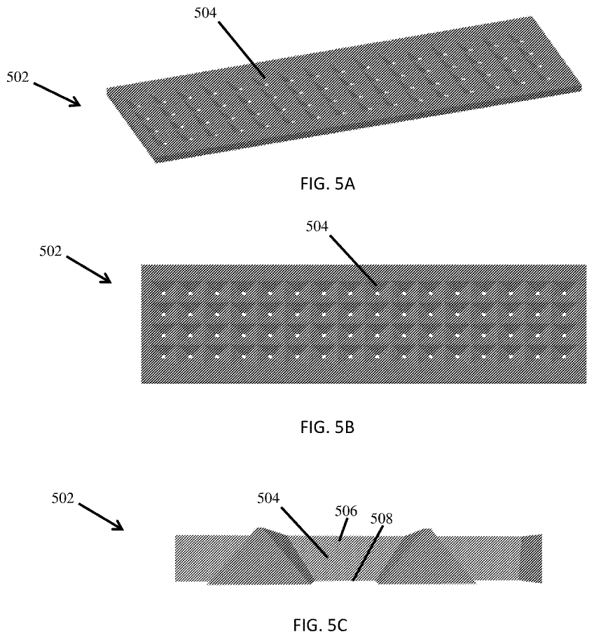

FIGS. 5A-5B illustrate perspective and top views of one embodiment of a directing well structure 502, respectively. As can be seen there, the directing well structure 502 may comprise a thin structure comprising a plurality of openings 504. The cross-sectional shape of the openings 504 at the proximal side may be configured to correspond to the cross-sectional shape of the separation wells 408. The openings 504 may have an inverted truncated square pyramidal shape, such that the cross-sectional area of the openings 504 decreases from proximal to distal. At the distal end of the opening 504, a portion of the transfer adapter 700 may be exposed.

FIGS. 5A-5B illustrate perspective and top views of one embodiment of a directing well structure, respectively. In these examples, directing well structure 502 comprises a thin structure comprising a plurality of openings 504. The cross-sectional shape of openings 504 at the proximal side may be configured to correspond to the cross-sectional shape of separation wells 408. Openings 504 may have an inverted truncated square pyramidal shape, such that the cross-sectional area of the openings decreases from a proximal end to a distal end. At the distal end of opening 504, a portion of transfer adapter 700 may be exposed. FIG. 5C illustrates a close-up view from the side of directing well structure 502 having openings 504 with an inverted truncated square pyramidal shape. In one aspect, the cross-sectional area of the openings at a proximal end 506 is greater than the cross-sectional area of the openings at a distal end 508. In other embodiments, the openings may have other shapes, such as but not limited to a truncated cone or a pyramidal frustum.

In one aspect, the directing well structure may be located between the separation well structure and the transfer adapter. In some embodiments in which the donor plate comprises a directing well structure, the donor plate may not comprise a separation seal. For example, the donor plate may comprise a directing well structure without a separation seal, and the directing well structure comprises a material such as a rubber, plastic, or polymer that may be capable of forming a seal between the transfer adapter and the separation well structure. In some embodiments, a directing well structure may be attached to a first planar surface (e.g., 704) of a transfer adapter (e.g., 700 as shown in FIG. 1C); a directing well structure may be attached to a boundary wall; a directing well structure may be attached to a boundary seal (e.g., by attaching the outer edges of the directing well structure to the inner edges of the boundary seal); and/or a directing well structure may be attached to a separation well structure. The directing well structure may be attached to these elements (e.g., the first planar surface, the boundary wall, the boundary seal, and/or the separation well structure) in any suitable manner, such as but not limited to adhesives (glues, adhesive polymers, and the like), chemical bonding, or the like. In some embodiments, the directing well structure may be fixedly attached to any of these elements (e.g., the first planar surface, the boundary wall, the boundary seal, and/or the separation well structure). In some embodiments, the directing well structure, transfer adapter, boundary wall, and/or separation well structure are integrally formed.

In other embodiments in which the donor plate comprises a directing well structure, the donor plate may also comprise a separation seal. For example, the donor plate may comprise both a directing well structure and a separation seal in embodiments in which the directing well structure comprises a material not generally capable of forming a sufficient seal between the transfer adapter, the directing well structure, and the separation well structure, such as glass or a hard plastic. In these embodiments, the separation seal may be located between the transfer adapter and the directing well structure and/or between the directing well structure and the separation well structure. When a separation seal is located between the transfer adapter and the directing well structure, the separation seal may be attached to the first planar surface of the transfer adapter, the distal surface of the directing well structure, or the boundary wall. When a separation seal is located between the directing well structure and the separation well structure, the separation seal may be attached to the proximal surface of the directing well structure, the distal surface of the separation well structure, or the boundary wall.

In some embodiments, the donor plates described herein may further comprise a cover. The cover may be configured to fit over the donor plates to cover the holding cavity. In some embodiments, the cover may be configured to individually seal the top of each separation well when the separation well structure is coupled within the holding cavity.

In some embodiments, at least one or each well of the plurality of wells may have a volume of about 100 μL to about 100 mL. In some embodiments, at least one or each well may have a volume of less than about 100 μL, about 100 μL to about 200 μL, about 200 μL to about 400 μL, about 400 μL to about 600 μL, about 600 μL to about 800 μL, about 800 μL to about 1 mL, about 1 mL to about 10 mL, about 10 mL to about 20 mL, about 20 mL to about 40 mL, about 40 mL to about 60 mL, about 60 mL to about 80 mL, about 80 mL to about 100 mL, or more than about 100 mL. In some embodiments, each of the plurality of wells may have a depth of about 1 mm to about 40 mm. In some embodiments, each of the plurality of wells may have a depth of about 5 mm to about 15 mm, about 10 mm to about 20 mm, about 15 mm to about 25 mm, about 20 mm to about 30 mm, about 25 mm to about 35 mm, about 30 mm to about 40 mm, or more than about 40 mm.

The multi-well container (e.g., plate) may comprise any suitable material or materials, including, but not limited to glass, plastic, and metal. In some embodiments, at least a portion of the interior surface of the well may comprise a coating, and in some embodiments, only the base may comprise a coating. A coating may perform one or more useful functions, such as immobilizing a target agent. For example, a coating may comprise one or more chemical compounds, proteins, gels (e.g., a hydrogel), polymers, co-polymers, fixed cells, micro-organisms, or the like.

Wells of a donor plate may be at least partially filled with any suitable contents. Generally, the contents of the donor wells of a donor plate used in the transfer systems described here may comprise one or more fluids and optionally one or more target agents. The one or more fluids may at least partially fill the donor wells. The target agents may be at least temporarily fixed or immobilized on an interior surface or base of the donor wells and immersed in the fluid. Through the transfer process, the fluid may be substantially transferred from the donor wells while the target agents may remain largely immobilized on the interior surface of the wells. Any suitable target agent may be used, for example a protein, a nucleic acid, a microorganism (e.g., bacteria, fungi), a plant (e.g., algae), a virus, a small molecule drug or any a chemical compound, a polymer, an antigen, an antibody, a cell fragment, a cell-homogenate, DNA, a peptide, or the like. The fluid may comprise any suitable fluid, such as an aqueous fluid.

A donor plate suitable for use with the material transfer systems described here may comprise one or more features to facilitate coupling, sealing, and/or alignment with the transfer adapter. In some embodiments, at least a portion of the top surface of the donor plate may be covered with an adhesive that may be configured to contact a surface of the transfer adapter. The adhesive may help couple the donor plate and transfer adapter together and/or form a seal that may prevent fluid from flowing between different wells of the donor plate. Additionally or alternatively, the top surface of the donor plate may comprise a structure that engages a corresponding structure on a surface of the transfer adapter. For example, the donor plate may have a lip around the perimeter of the top surface, around the donor wells, or at any other suitable location that may fit into a corresponding groove on the transfer adapter. This may contribute to coupling, sealing, and aligning the donor wells of the donor plate with the openings of the transfer adapter. As other examples, the donor plate may comprise a clip, clamp, latch, or the like configured to interface with the transfer adapter. The donor plate may also be configured to interface with a clip, clamp, latch, or the like on the transfer adapter. The clip, clamp, latch, or the like may attach to the transfer adapter and/or to the receiver plate in order to facilitate coupling, sealing, and/or alignment of two or more plates.

While the donor plate is in some embodiments described as a separate and distinct element from the transfer adapter, it should be appreciated that in some embodiments, the donor plate may be integrally formed with the transfer adapter. In these embodiments, the combined donor plate-transfer adapter may couple with a receiver plate to facilitate transfer of a material (e.g., a fluid) from the wells of the donor plate to the wells of the receiver plate. A combined donor plate-transfer adapter may be configured to allow or prevent the mixing of fluid from different wells of the donor plate.

### Transfer Adapter

In one aspect, the transfer systems described here may comprise a transfer adapter configured to regulate the transfer of fluid to or from wells of a multi-well plate. When the plates of a transfer system are combined to form a transfer assembly a first side of the transfer adapter may be coupled (reversibly or irreversibly) to a donor plate, and a second, opposite side of the transfer adapter may be coupled (such as reversibly) to a receiver plate. In some embodiments, the transfer adapter and donor plate are integrally formed and an exposed surface of the transfer adapter may be coupled (such as reversibly) to a receiver plate. The transfer adapter may comprise a planar sheet with a plurality of openings, and the layered arrangement of the transfer assembly may allow fluid to flow from the wells of the donor plate, through the openings in the transfer adapter, and into the receiver plate. To facilitate this flow of fluid there may in general be at least as many openings in the transfer adapter as there are wells in the donor plate, and the openings may be arranged such that each opening of the transfer adapter aligns with a different well of the donor plate. For example, the distance between the centers of adjacent openings, the arrangement of openings in rows and columns, and the number of openings in each row and column may match the arrangement of wells in the donor plate. In some embodiments, the transfer adapter may be configured to have more than one opening align with each well of the donor plate. In embodiments of transfer assemblies comprising a receiver plate with a plurality of receiver wells, each opening of the transfer adapter may align with a different receiver well, or more than one opening may align with each receiver well.

The transfer adapter may comprise one or more features to facilitate the alignment of the openings with the wells of the donor plate and, in some embodiments, with the receiver wells of the receiver plate. For example, the transfer adapter may comprise one or more structures in proximity to at least one opening that may act as an insertion guide to aid in alignment as the transfer adapter and donor plate are coupled. In some embodiments, these structures may comprise an extension that protrudes from the surface of the planar sheet adjacent to or surrounding each opening. Each extension may engage (e.g., contact, enter, at least partially fit into) a different donor well to align the openings with the donor wells. The transfer adapter may comprise extensions on a first side to engage the wells of the donor plate and/or on a second side to engage receiver wells of the receiver plate.

The transfer adapter may additionally or alternatively comprise an alignment guide that aligns with a predetermined portion of the donor plate. For example, an alignment guide may be one or more dimensions (e.g., length, width) of the transfer adapter that may match a corresponding dimension of the donor plate. Aligning corresponding dimensions of the transfer adapter and the donor plate may also align the openings with the wells. As another example, the alignment guide may comprise one or more pins and/or recesses configured to interface with a corresponding feature on the donor plate. It should be appreciated that the transfer adapter may have the same or a different alignment guide that may align with a predetermined portion of the receiver plate in order to align the openings with the receiver wells.

In one aspect, coupling the transfer adapter to the donor plate and receiver plate may form fluid-tight or leak-proof seals. For example, the seals may be formed between each well of the donor plate and the transfer adapter in order to block the flow of fluid between donor wells. In other words, fluid may be permitted to flow out of a donor well and through an opening in the transfer adapter, but the seal may prevent the fluid from flowing out of one donor well and into a different donor well. Preventing mixing of fluid between donor wells may be desirable when, for example, different experimental protocols have been performed in different donor wells, and therefore it is desirable to keep the well contents isolated. When the receiver plate comprises a plurality of receiver wells, it may be desirable to form seals between each receiver well and the transfer adapter in order to isolate the transferred fluid from each well of the donor plate. Another function of the seals may be to hold the plates of the transfer assembly together by friction so that they are not separated inadvertently.

In one aspect, the transfer adapter may comprise one or more features to facilitate the sealing. For example, in embodiments of transfer adapters comprising extensions, each extension may fit into and seal against the interior surface of a well (e.g., a donor well of a donor plate or a receiver well of a receiver plate). The size and shape of a portion of the extension may match the size and shape of a portion of the well, and these portions may interact to form the seal. The material properties of the extensions and/or the wells may improve the seals (e.g., decrease the chances of fluid leaking through the seal, and/or increase the force required to break the seal). For example, an extension may comprise one or more compliant materials (e.g., a rubber, a plastic, or a polymer). This may allow the extension to conform to the shape of the well. The materials of the extensions and wells may also be chosen to increase or decrease the frictional force holding the extensions and wells together.

Some embodiments of transfer adapters may not comprise extensions or other structures that enter the wells of a donor plate or a receiver plate. In these embodiments, a planar surface of the transfer adapter may seal against a top surface of the donor plate around the well openings. The transfer adapter and/or donor plate may comprise one or more features to facilitate the sealing of these surfaces. For example, an adhesive may be on the surface of the transfer adapter and/or the donor plate. Additionally or alternatively, a clip or a clamp may compress surfaces of the transfer adapter and donor plate together. It should be appreciated that any of the sealing mechanisms described here that may seal the wells of the donor plate against the transfer adapter may also be used to seal the receiver wells of the receiver plate against the transfer adapter. In some embodiments, a planar surface of the transfer adapter may be fixedly coupled to a bottom surface of a donor plate.

The transfer adapter may regulate the flow of fluid in multiple ways. For example, the alignment and sealing mechanisms may direct the flow of fluid through the openings. In other examples, one or more features of the transfer adapter may determine the amount of force required to cause fluid to flow through the openings. In some embodiments, the size and/or shape of an opening may be such that the force of gravity acting on the fluid in a donor well positioned above the transfer adapter may result in the fluid flowing through the opening. In other embodiments, the size and/or shape of an opening may be such that the force of gravity alone may not result in fluid flowing through the opening. For example, if an opening comprises one or more small holes or slits, cohesive forces of the fluid (e.g., surface tension) and adhesive forces between the fluid and transfer adapter may prevent fluid flow. Thus, the magnitude of force required to cause a substantial flow of fluid through the opening may depend of the size and/or shape of the opening, the properties of the material surrounding the opening (e.g., hydrophobicity, hydrophilicity), and the properties of the fluid (e.g., viscosity). If a transfer adapter is configured such that cohesive and adhesive forces prevent the flow of fluid through the openings due to the force of gravity alone, then the application of an external force, such as the force produced by a centrifuge, may generate fluid flow.

Additionally or alternatively, the transfer adapter may be configured such than an external force (e.g., from centrifuging the transfer adapter) may change the area of each opening. For example, in some embodiments, one or more leaflets may surround and/or define the area of each opening. Without any external force applied, the leaflets may be in a closed, first position, blocking the flow of fluid through the openings. In this first position, the opening may be completely closed or the area may be sufficiently small to prevent the flow of fluid due to the force of gravity. When an external force is applied to the transfer adapter (e.g., by centrifuging the transfer adapter), the leaflets may deflect, deform, or otherwise move to a second, open position. The area of the opening may increase when the leaflets are in the second, open position, and fluid may be able to flow through the openings. A transfer adapter that allows substantial flow of fluid only when an external force is applied may have several advantages. For example, this may prevent fluid from inadvertently flowing from the receiver plate back into the donor plate after fluid transfer. This configuration may also allow the transfer adapter to function as a fluid-tight cover or lid for the donor plate.

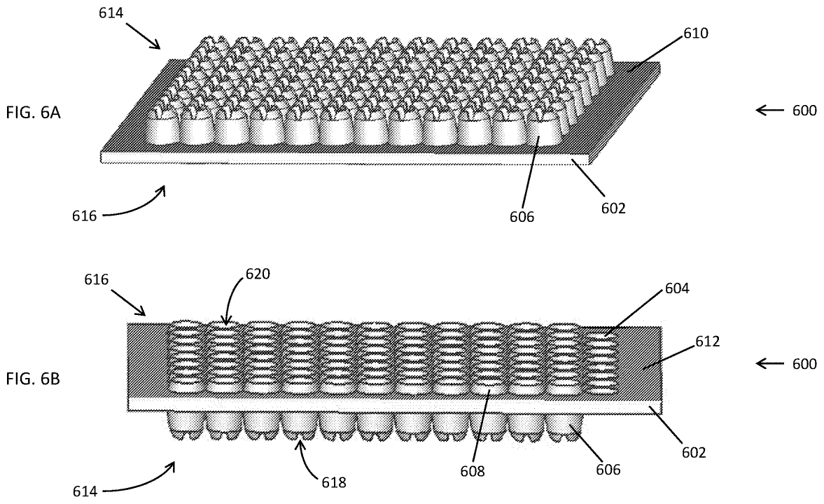

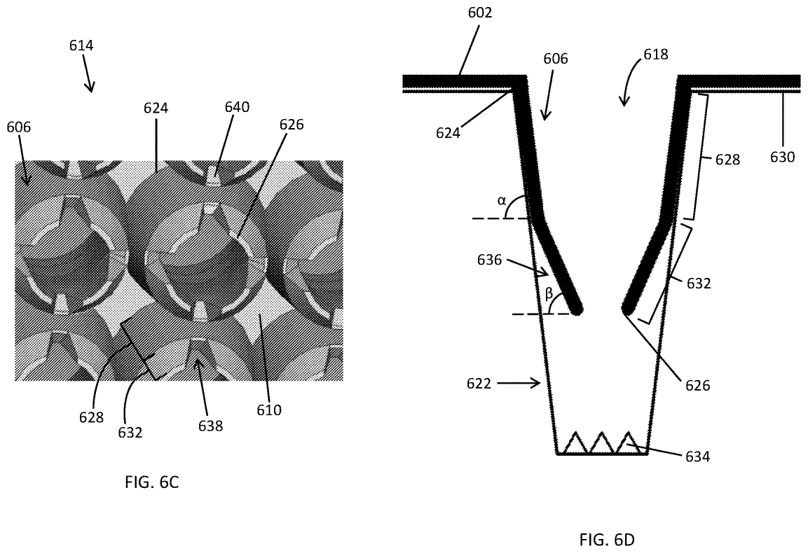

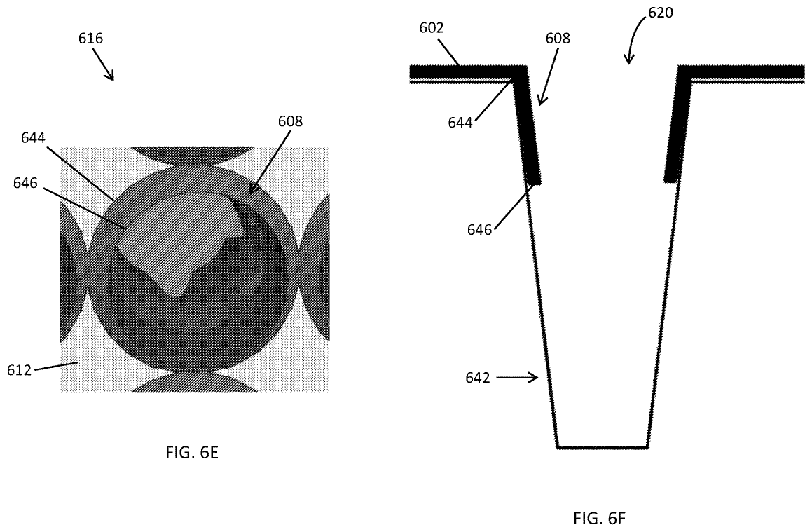

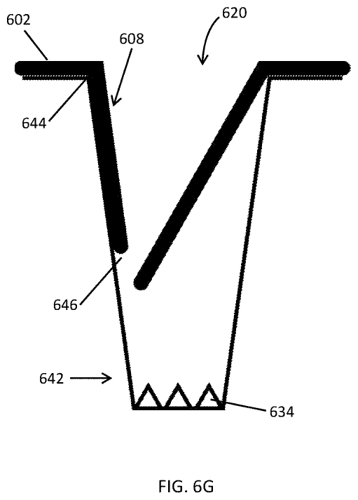

Examples of a transfer adapter configured for use with a multi-well container (e.g., a 96-well plate) are depicted in FIGS. 6A and 6B. In FIG. 6A, transfer adapter 600 comprises a substrate (e.g., planar sheet 602), a plurality of openings on the substrate, as well as primary extension 606 and secondary extension 608 associated with each opening. In this example, the openings and associated primary and secondary extensions are arranged to correspond to the wells of a 96-well plate, e.g., in six rows×12 columns. However, it should be understood that the openings and associated primary and secondary extensions may be arranged in any suitable pattern in order to correspond to some or all of the wells of any multi-well container.

In order to better show the openings, FIG. 6B depicts one column of openings 604 without the primary and secondary extensions. In one aspect, each opening comprises a through hole that extends between a first surface and a second surface of the substrate. For example as shown in FIG. 6B, opening 604 is a through hole that extends between first planar surface 610 and second planar surface 612 of planar sheet 602. In this example, there are 96 openings 604 that are arranged such that each opening aligns with a different well of a 96-well plate when a transfer assembly is formed.

In one aspect, the transfer adapter comprises a primary extension protruding from a first surface around an opening on the transfer adapter substrate. For example as shown in FIGS. 6A and 6B, transfer adapter 600 comprises primary extension 606 that protrudes from first planar surface 610 around each opening 604. In another aspect, the transfer adapter further comprises a secondary extension protruding from a second surface around an opening on the transfer adapter substrate. For example as shown in FIG. 6B, in addition to primary extensions 606, transfer adapter 600 further comprises secondary extension 608 may that protrudes from second planar surface 612 around each opening 604.

In one aspect, a primary extension comprises a primary lumen and/or a secondary extension comprises a secondary lumen. For example as shown in FIG. 6B, each primary extension 606 comprises primary lumen 618, and each secondary extension 608 comprises a secondary lumen 620. In some embodiments, a primary lumen and a secondary lumen are configured to form a continuous transfer lumen that extends between a first side and a second side of the transfer adapter. For example, the primary lumen and the secondary lumen are both configured to fluidly connect to the same opening on the transfer adapter substrate, thereby forming a continuous transfer lumen through the substrate. As shown in FIG. 6B, each primary lumen 618 is aligned with and/or configured to fluidly connect to its corresponding opening 604 and secondary lumen 620, thereby forming a continuous transfer lumen that extends between first side 614 and second side 616 of transfer adapter 600. In some embodiments, when the first side of the transfer adapter is coupled to a donor plate, each transfer lumen can be aligned with a different well of the donor plate, in order to facilitate fluid flow out the plurality of wells, through the plurality of transfer lumens, and into a receiver plate.

In another aspect, a primary extension facilitates alignment and/or sealing of a transfer adapter and a donor plate, thereby facilitating fluid flow from a donor plate well through an opening of the transfer adapter. In one embodiment, a primary extension is configured to at least partially fit into and seal against a well of a donor plate. In particular embodiments, the primary extension is configured to form a seal (e.g., a fluid-tight seal) with an interior surface of the donor plate well. For example as shown in FIGS. 6C and 6D, each primary extension 606 is configured to at least partially fit into and seal against (e.g., form a seal with an interior surface of) a different well of a donor plate. Detail of the primary extensions may be seen in the close-up view of a portion of the transfer adapter's first side 614 in FIG. 6C. A cross-sectional view of primary extension 606 inserted into well 622 of a multi-well plate is provided in FIG. 6D. In some embodiments, a primary extension comprises an inner end adjacent to the transfer adaptor substrate and an outer end distal to the substrate. For example as shown in FIG. 6D, each primary extension 606 may comprise inner end 624 adjacent to planar sheet 602 and outer end 626 distal to the planar sheet. In one embodiment, a primary extension tapers from the inner end to the outer end such that an inner cross-section is greater in area than an outer cross-section of the primary extension. For example as shown in FIG. 6D, each primary extension 606 tapers from inner end 624 to outer end 626 such that an inner cross-sectional area is greater than an outer cross-sectional area. In one aspect, an outer cross-sectional area of a primary extension is less than an interior cross-sectional area of a well, such that the outer end of the primary extension can be easily inserted and advanced in the well. For example as shown in FIG. 6D, when outer end 626 of primary extension 606 is inserted in well 622, an outer cross-sectional area of the outer end of the primary extension is less than a corresponding interior cross-sectional area of the well, e.g., when the cross-sectional area of the outer end and the cross-sectional area of the well opening are taken at the same cross-sectional plane. Moreover, inserting outer ends 626 of primary extensions 606 into wells 622 may align each primary lumen 618 and each opening of the transfer adapter with a different well of the donor plate.

In yet another aspect, on an external surface of a primary extension, there is provided a sealing region configured to contact and seal against an interior surface of a well. For example as shown in FIG. 6D, outer end 626 of primary extension 606 may be advanced into well 622 until a portion of the external surface of the primary extension, sealing region 628, contacts and seals against an interior surface of well 622. In one aspect, when the seal is formed, the cross-sectional shape and area of the primary extension (on its external surface) are substantially the same as the interior cross-sectional shape and area of the portion of the well that the sealing region contacts. In one aspect, this enables a continuous seal to be formed between an external perimeter of the primary extension and an internal perimeter of the well. In the example shown in FIGS. 6A-6C, the cross-sectional shape of primary extension 606 may be circular, allowing it to form a continuous, circumferential seal with a well that also has a circular cross-sectional shape. However, a sealing region of a primary extension may have any shape that matches an interior cross-sectional shape of a well (e.g., square, rectangle, oval, or ellipse). In some embodiments, a primary extension is fully inserted into a well in order to form a fluid-tight seal against the well at the sealing region. In other embodiments, partial insertion of a primary extension into a well is sufficient to form a fluid-tight seal against the well. For example, while FIG. 6D depicts primary extension 606 fully inserted into well 622, it should be appreciated that in some embodiments, a fluid-tight seal may be formed before the primary extension is entirely within the well.

In one aspect, a primary extension comprises one or more portions with different slopes or angles relative to the transfer adaptor substrate. In some instances, a primary extension comprising two or more slopes is advantageous compared to a primary extension with one slope. For example as shown in FIGS. 6C and 6D, primary extension 606 comprises at least two portions with different slopes or angles relative to planar sheet 602. Specifically, the external surface of sealing region 628 has a first slope with angle α relative to planar sheet 602, and the external surface of an end of the primary extension distal to planar sheet 602 (e.g., region 632 of primary extension 606) has a second slope with angle β relative to the planar sheet. In some embodiments, the first slope may be substantially the same as the slope of the interior surface of well 622, which may maximize the area of contact between sealing region 628 and an interior surface of the well. In some embodiments, the walls of well 622 are vertical (e.g., perpendicular to top surface 630 of the multi-well plate), and the first slope may therefore be vertical (e.g., perpendicular to planar sheet 602 of the transfer adapter). In some embodiments, the second slope of region 632 may be less than the slope of sealing region 628 (i.e., angle β may be less than angle α), and thus region 632 may not contact and seal against an interior surface of well 622. In one aspect, the lesser second slope may result in a smaller cross-sectional area at outer end 626, thereby facilitating insertion of the primary extension into well 622. In another aspect, the lesser slope may decrease the length of primary extension 606, e.g., resulting in a shorter longitudinal distance between inner end 624 and outer end 626. This configuration may decrease the chances of contact between the primary extension and a target agent in the well, for example, target agent 634 at a bottom base of well 622.

In one aspect, a pocket may be formed between the primary extension and an interior surface of the well if the slope of a distal region of the primary extension is less than the slope of the interior surface of the well. For example, FIG. 6D shows pocket 636 formed between primary extension 606 and well 622, because the slope of region 632 is less than the slope of the interior surface of the well when the primary extension is inserted into the well. In this example, when the transfer assembly is inverted, or during centrifuging, fluid may enter this pocket 636 instead of flowing directly into primary lumen 618 and subsequently out of well 622.

In one aspect, a primary extension comprises one or more features to decrease the chances that fluid becomes trapped between a transfer adaptor and a well, e.g., between the primary extension and an interior surface of the well, such as in pocket 636. In some embodiments, the one or more features comprise a feature in the structure, size, and/or shape of the primary extension (e.g., a slit, a gap, a notch, an aperture, a grove, a channel, etc.), and/or a feature in a property of a material of the primary extension (e.g., hydrophobicity or hydrophilicity). For example, as shown in FIG. 6C, each primary extension 606 may comprise one or more slits 638 (e.g., four slits 638) that are configured to fluidly connect to primary lumen 618. In one aspect, a slit may be a gap in the perimeter of the primary extension, e.g., in region 632. In one aspect, fluid that enters a pocket may flow through the slit or gap into the primary lumen and exit the well, as opposed to remaining trapped in the pocket. In another aspect, as shown in FIG. 6C, each slit 638 may comprise a sloped or angled base 640 pointing toward the center of primary lumen 618, thereby directing fluid out of pocket 636, into the primary lumen, and eventually out of well 622. While slits are shown in FIG. 6C, it should be appreciated that any structure that is configured to fluidly connect the pocket to the primary lumen may decrease the chances of fluid being retained in the pocket. In some embodiments, the structure comprises an aperture, a hole, a slit, a gap, a notch, a grove, or a channel, etc.

In some embodiments, the primary extension comprises a region that has an outer slope that is the same as the slope of the interior surface of the well and an inner slope that is less than the slope of the interior surface of the well, where there is no pocket because a material of the primary extension would have filled the pocket. For example, referring to FIG. 6D, primary extension 606 may comprise region 632 that has an outer slope that is the same as the slope of the interior surface of the well and an inner slope that is less than the slope of the interior surface of the well, where there is no pocket 636. In such a primary extension, outer end 626 of primary extension 606 may comprise a surface that is curved or angled (e.g., concave or conical) in such a way as to guide fluid from the well into primary lumen 618.

Turning to the second side of the transfer adapter, in some embodiments, there can be some structural similarities to the first side, while the second side is configured to couple with a receiver plate. For example, in a transfer system where a receiver plate comprises a plurality of receiver wells, the second side of the transfer adapter may comprise a plurality of secondary extensions configured to engage (e.g., to be inserted into) the receiver wells. In some embodiments, a transfer adapter of the present disclosure comprises a secondary extension that protrudes from a second surface of the transfer adaptor substrate. For example, FIG. 6E shows a magnified view of a portion of a second side (616) of the transfer adapter, which comprises secondary extensions 608 that protrude from second planar surface 612 of planar sheet 602. FIG. 6F is a cross-sectional view of secondary extension 608 inserted into and sealed against an interior surface of receiver well 642. In this example, each secondary extension may be aligned with and surround a different opening of the transfer adaptor substrate. In some embodiments, a secondary extension comprises a secondary lumen that is configured to fluidly connect with an opening of the transfer adaptor substrate, and in turn with a primary lumen of a primary extension. For example, secondary lumen 620 may fluidly connect with opening 604 and primary lumen 618, thereby forming a continuous transfer lumen that extends between first side 614 and second side 616 of transfer adapter 600. In some embodiments, the secondary extension may taper from an inner end adjacent to the substrate (e.g., a planar sheet) to an opposite, outer end distal to the substrate. For example, as shown in FIG. 6F, secondary extension 608 may taper from inner end 644 adjacent to planar sheet 602 to outer end 646 distal to the planar sheet. In other words, a cross-sectional area of secondary extension at the inner end may be greater than a cross-sectional area at the outer end.

In some embodiments, the outer end is configured such that fluid exiting from the outer end into the receiver well is guided to a wall of the receiver well, rather than being directed to the center of the receiver well. In one aspect, this configuration reduces or eliminates the impact of the exiting fluid on one or more contents of the receiver well. For example as shown in FIG. 6G, outer end 646 is configured to point to a wall of the receiver well rather than the center of the receiver well, such that such that a fluid exiting from the outer end is guided to the wall rather than being directed to the center of the receiver well which may contain one or more agents 634. Such embodiments may reduce the amount of disturbance of a content on the base of receiver well 642 resulting from fluid transfer. It is to be appreciated that the size of the opening of outer end 646 and its distance from the base of receiver well 642 can also be varied to eliminate, reduce, or achieve minimal disturbance of target agent 634 on the bottom base of the receiver well. In examples where a cell or tissue culture is grown on the bottom of the receiver well, a configuration as shown in FIG. 6G may be used to avoid disturbance of the cell or tissue culture during liquid transfer.

In other embodiments, one or more agents may be provided on an interior wall of the receiver well, rather than on the bottom base of the receiver well. Depending on the purpose of the fluid transfer, a suitable configuration of the secondary extension can be chosen. For example, if the transferred fluid is intended to contact the one or more agents on the interior wall (e.g., to reconstitute a lyophilized reagent on the wall), a configuration as shown in FIG. 6G may be used to facilitate the contact. However, if contact and/or impact on the agent should be avoided (e.g., because cells are grown on the wall), the secondary extension may be configured to direct fluid toward the bottom plate rather than the interior wall of the receiver well.

In some embodiments, the tapered shape of the secondary extension enables the outer end to be inserted into the inlet of the receiver well, thereby aligning each secondary lumen and the opening of the transfer adapter with a different receiver well. For example as shown in FIG. 6F, secondary extension 608 may be advanced into receiver well 642 until at least a portion of the external surface of the secondary extension contacts and seals against a portion of the interior surface of the receiver well. The portions of secondary extension 608 and receiver well 642 that form the seal (e.g., a fluid-tight seal) may have the same cross-sectional area and shape in order to form a continuous seal around the perimeters of the secondary extension and receiver well. This seal may block the flow of fluid between receiver wells 642. While the secondary extensions 608 shown in FIGS. 6E and 6F comprise only one slope and no slits, it should be appreciated that the secondary extensions may comprise any of the features described here with respect to the primary extensions, including two or more portions with different slopes, and one or more slits.

In another aspect, a transfer adapter disclosed herein comprises a planar sheet with a first planar surface and a second planar surface, and a plurality of openings that extend between the first planar surface and the second planar surface. For example as shown in FIG. 7A, transfer adapter 700 is positioned above a multi-well plate, and a close-up view of a portion of this transfer adapter is shown in FIG. 7B. In these examples, transfer adapter 700 comprise planar sheet 702 with first planar surface 704 and second planar surface 706, and a plurality of openings 708 that extend between the first planar surface and the second planar surface. In some embodiments, the transfer adapter lacks the primary extension and/or the secondary extension described with respect to the transfer adapter embodiments shown in FIGS. 6A-6F. For example, transfer adapter 700 may comprise openings 708, which are arranged such that each opening aligns with a different well of a donor plate 710 (e.g., a 96-well plate). In some embodiments, at least one or all of the wells of the donor plate may seal against the first planar surface of the transfer adapter, which may reduce the chances of fluid mixing between the wells. Thus, in one aspect, each opening 708 of transfer adapter 700 may align with a different donor well of a donor plate, and each donor well may seal against first planar surface 704 of the transfer adapter. In some embodiments, the first planar surface of the transfer adapter is fixedly coupled to a bottom surface of a donor plate (e.g., 300) and/or a bottom surface of a separation well structure (e.g., 400). The transfer adapter and the donor plate may be integrally formed, optionally including the separation well structure. Similarly, in embodiments of transfer systems comprising a receiver plate with a plurality of receiver wells, each opening (e.g., 708) of the transfer adapter may align with a different receiver well, and each receiver well may seal against the second planar surface (e.g., 706) of the transfer adapter.

In one aspect, the transfer adapter may comprise one or more features to facilitate alignment of the openings with the donor wells of the donor plate and/or the receiver wells of the receiver plate. For example, one or more sides of transfer adapter 700 may have the same size (e.g., length and/or width) as a corresponding side of the donor plate and/or the receiver plate. The transfer adapter and the donor plate and/or the receiver plate may be configured such that aligning corresponding sides may also align the openings (e.g., 708) with the donor wells of the donor plate and/or the receiver wells of the receiver plate.

In another aspect, the transfer adapter (e.g., 700) is configured to enable the donor wells of the donor plate (e.g., 710) to seal against the first planar surface (e.g., 704) and/or the receiver wells of the receiver plate to seal against the second planar surface (e.g., 706). For example, the first planar surface may be at least partially covered with an adhesive. When the transfer assembly is formed, the first planar surface of the transfer adapter may engage a top surface (e.g., 712) of the donor plate, and the adhesive may reversibly or irreversibly attach the two surfaces and form a fluid-tight seal between them. Thus, fluid may be permitted to flow out of a well of the donor plate through an opening (e.g., 708), but the seal may block fluid from flowing between the first planar surface of the transfer adapter and the top surface of the donor plate to reach a different well. Similarly, an adhesive may at least partially cover the second planar surface of the transfer adapter in order to form a seal with a surface of the receiver plate and block the flow of fluid between receiver wells.

In some embodiments, an adhesive may cover the entire first and/or second planar surfaces (e.g., 704 and 706, respectively), and in other embodiments, it may be desirable for the adhesive to cover only a portion of the first and/or second planar surfaces. For example, in order to reduce the risk of the adhesive contaminating the contents of the wells of the donor plate (e.g., 710) and/or the receiver wells of the receiver plate, the first and/or second planar surfaces of the transfer adapter may lack adhesive in areas that might contact fluid (e.g., around openings 708). It should be appreciated that while an adhesive may cover one or more surfaces of the transfer adapter, the same or a different adhesive may additionally or alternatively cover a surface of the donor plate and/or the receiver plate.

The transfer adapter (e.g., 700) may be configured to control the amount of force that may cause fluid to flow through the openings (e.g., 708). For example, the transfer adapter may be configured so that if the transfer assembly is positioned such that the donor plate (e.g., 710) is above the transfer adapter, the force of gravity may not be sufficient to generate a substantial flow of fluid through the openings. In order for fluid to flow through the openings and be transferred from the wells of the donor plate, an external force, such as from a centrifuge, may be applied to the transfer assembly. At least the size and/or shape of each opening (708) (e.g., the cross-sectional area and/or the width), the material or materials of the transfer adapter, and/or the properties of the fluid (e.g., viscosity) may determine the force required to cause the fluid to flow through the opening. For example, decreasing the size of the opening, increasing the hydrophobicity of the material bordering the opening, and/or increasing the cohesive forces (e.g., surface tension) of the fluid may increase the magnitude of force needed to cause substantial flow of fluid through the opening. While openings 708 shown in FIGS. 7A-7B are cross-shaped, an opening may have any shape (e.g., square, rectangle, circle, or ellipse) and the transfer adapter may still be configured to prevent the flow of fluid through the openings due to the force of gravity. FIG. 7C shows an example of using a centrifugal force to transfer fluid into the wells. In one aspect, a precut hole or slit in transfer adaptor (e.g., made of rubber) would seal under normal gravitational condition (e.g., FIG. 7C, left), while the precut hole or slit in rubber opens during centrifuge when increased centrifugal force pressures the fluid through the hold or slit (e.g., FIG. 7C, right).

While FIG. 7C shows one opening for illustration, in some embodiments, the present transfer adaptor comprises a plurality of openings, for example as shown in FIGS. 7A-7B. In one aspect, the plurality of subdivisions of a liquid help reduce the interference of unequal meniscus formation (where the liquid meets a container wall) in the subdivisions. For example, as FIG. 7D shows, without the subdivisions, more meniscus formation (and thus more volume) is seen in a position closest to a wall, while a position in the center has less volume. By providing a plurality of subdivisions, equal volume in each subdivision may be achieved, and the interference of unequal meniscus formation is reduced or eliminated.

In some embodiments, the transfer adapter may be configured to have one opening align with each well of the donor plate, whereas in other embodiments, the transfer adapter may be configured to have more than one opening align with each well of the donor plate. For example, the transfer adapter may be configured such that multiple small openings align with each well.

In some embodiments, an external force, such as from a centrifuge, may change the size and/or shape of each opening (e.g., 708), which may increase the flow of fluid through the opening. For example, one or more leaflets (e.g., four leaflets 714) may surround and/or define the area of each opening, and the leaflets may move to change the area of the opening. Without any external force applied to the transfer adapter (e.g., 700), the leaflets may be in a first, closed position as they appear in FIGS. 7A-7B. When the leaflets are in the closed position, the area of each opening may be minimized. The transfer adapter may be configured such that when the area of each opening is minimized and only the force of gravity is applied to the fluid, fluid may not flow through the openings. In these embodiments, the area of each opening when minimized may be approximately zero (e.g., the openings may be entirely closed) or the opening may be configured such that cohesive forces within the fluid and/or the adhesive forces between the fluid and the transfer adapter may prevent the flow of fluid through the openings. When an external force is applied to the transfer adapter, at least a portion of each leaflet may deflect or otherwise move out of the horizontal plane of the planar sheet (e.g., 702), and the leaflets may be in a second, open position. When the leaflets are in the open position, the area of each opening may be greater than it is when the leaflets are in the closed position, thereby enabling flow of fluid through the opening. The transfer adapter may be configured such that a desired force is required to move the leaflets from the closed position to the open position and to allow the flow of fluid through the openings. For example, the size, shape and material of the leaflets may at least partially determine how easily they may move.

It should be appreciated that any of the transfer adapter features described may be combined in any suitable way. For example, an embodiment of a transfer adapter may comprise some components from the embodiment discussed with respect to FIGS. 6A-6F and other components from the embodiment discussed with respect to FIGS. 7A-7B. Specifically, an embodiment of a transfer adapter may comprise primary and secondary extensions to facilitate alignment and sealing of the transfer adapter with the donor plate and receiver plate, respectively. This embodiments may also have openings, such as the cross-shaped openings 708 shown in FIGS. 7A-7B, that are configured to block the flow of fluid unless an external force is applied to the transfer adapter. In addition, the transfer adapter may or may not have an adhesive on one or more surfaces to facilitate sealing and/or coupling of the transfer adapter with the multi-well plate and/or the receiver plate.

A transfer adapter may comprise one or more additional or alternate features to facilitate interactions with a donor plate and/or a receiver plate. For example, the transfer adapter may comprise permanent or removable clips or clamps to aid in coupling, aligning, and/or sealing of the transfer adapter with the donor plate and/or the receiver plate. In some embodiments, the transfer adapter may be configured for use with one size or type of donor plate and/or receiver plate. For example, a transfer adapter may have a fixed number of openings, and this number of openings may be the same as the number of openings in one type of donor plate. In other embodiments, one transfer adapter may be used with multiple sizes or types of donor and/or receiver plates. For example, a transfer adapter may comprise one or more sections that may be permanently or reversibly separated and/or connected to decrease or increase the size of the transfer adapter, thereby decreasing or increasing the number of openings.

In any of the preceding embodiments, the transfer adapter may comprise a suitable material, such as but not limited to a rubber, a plastic, a polymer, or the like.

### Receiver Plate

In some embodiments, the transfer systems described here may comprise a receiver plate that may couple with a transfer adapter and contain the fluid transferred from wells of a donor plate. When the transfer assembly is formed, the receiver plate may reversibly attach to a side of the transfer adapter opposite from the side where the donor plate attaches. Fluid may then flow out of the wells of the donor plate, through the openings in the transfer adapter, and into the receiver plate. Containing the transferred fluid in a receiver plate may prevent the fluid from escaping into the centrifuge and may allow studies to be performed on the fluid after it has been separated from the target agents. In some embodiments, the receiver plate may be configured to prevent mixing of fluid transferred from different wells of the donor plate. For example, the receiver plate may comprise a plurality of receiver wells, and fluid transferred from each well of the donor plate may flow into a different receiver well. In other embodiments, fluid transferred from different wells of the donor plate may mix in the receiver plate. For example, the receiver plate may comprise only one receiver well that fluid from every well of the donor plate may flow into.

The contents of the receiver wells of a receiver plate used in the transfer systems described here may comprise one or more target agents. The target agents may be at least temporarily fixed or immobilized on an interior surface or base of the receiver wells. Through the transfer process, fluid may be substantially transferred from donor wells to the receiver wells while the target agents may remain largely immobilized on the interior surface of the receiver wells. Any suitable target agent may be used, for example a protein, a nucleic acid, a microorganism (e.g., bacteria, fungi), a plant (e.g., algae), a virus, a small molecule drug or any a chemical compound, a polymer, an antigen, an antibody, a cell fragment, a cell-homogenate, DNA, a peptide, or the like.

In embodiments of receiver plates configured to prevent mixing of fluid transferred from different wells of the donor plate, the number and arrangement of receiver wells may be the same as the number and arrangement of openings in the transfer adapter and wells in the donor plate. Alignment of the receiver plate with the transfer adapter and donor plate may therefore align each receiver well with a different opening of the transfer adapter and a different well of the donor plate. Each receiver well may have any of the sizes and shapes discussed with respect to the wells of the donor plate, so long as the volume of each receiver well may be large enough to accommodate the fluid transferred from one well.

In order to block the flow of fluid between different receiver wells, the receiver plate may be configured to seal against the transfer adapter. For example, in embodiments of transfer systems comprising a transfer adapter with secondary extensions, as shown in FIGS. 6A, 6B, 6E, and 6F, each secondary extension may fit into and seal against a different receiver well. As was described in more detail with respect to FIG. 6F, at least a portion of the receiver well may have the same cross-sectional size and shape as at least a portion of the secondary extension. This may facilitate the formation of a continuous, circumferential seal between an exterior surface of the secondary extension and an interior surface of the receiver well.

In some embodiments of receiver plates that comprise a plurality of receiver wells, the receiver plate may be a standard, off-the shelf multi-well plate. For example, in some embodiments of transfer systems, the receiver plate may be the same as the donor plate. In other embodiments, the receiver plate may be a different type of standard multi-well plate than the donor plate. For example, the donor plate may be coated with material to immobilize target agents, whereas the receiver plate may not comprise such a coating, or vice versa.

The embodiments of a receiver plate shown in the transfer system in FIGS. 1A and 1B may be a standard multi-well plate. As seen there, the receiver plate (108) may comprise a contact surface (126) and a plurality of receiver wells (118). The contact surface may be configured to face or contact the transfer adapter (106) when the transfer assembly (102) is formed. Fluid may flow into each receiver well (118) through an opening or inlet (124).

In some embodiments, a receiver plate may allow mixing of fluid transferred from different wells of a donor plate. For example, a receiver plate may comprise fewer receiver wells than there are openings in the transfer adapter and wells in the donor plate, and/or a plurality of receiver wells may be fluidly connected. A receiver plate configured to allow mixing of transferred fluid may permit mixing between fluid transferred from only some of the wells of the donor plate (e.g., one half of the wells may flow into a first receiver well and the other half of the wells may flow into a second receiver well, each row or column of wells may flow into a different receiver well, or the like). In other embodiments, the receiver plate may be configured to allow mixing of fluid transferred from every well of the donor plate. For example, the receiver plate may comprise a single receiver well and fluid transferred from every well of the donor plate may flow into the single receiver well. In still other embodiments, the receiver plate may be adjustable to change the number of receiver wells, which may change the degree of fluid mixing allowed. For example, the receiver plate may comprise one or more removable, combinable, and/or separable walls that may be adjusted to change the number of receiver wells.

In another aspect, a receiver plate may comprise one or more features to facilitate alignment, sealing, and/or coupling with a transfer adapter. For example, even in embodiments of receiver plates that may allow mixing of the fluid transferred from different wells of the donor plate, it may be advantageous for the receiver plate to seal against the transfer adapter in order to prevent leakage of fluid out of the transfer system (e.g., leakage into the centrifuge). In some embodiments, at least a portion of the contact surface of the transfer adapter may be covered with an adhesive to facilitate sealing. The adhesive may maintain contact between at least a portion of the contact surface of the receiver plate and a surface of the transfer adapter and prevent fluid from moving between the two surfaces. Additionally or alternatively, a clip or clamp may hold the contact surface of the receiver plate and a surface of the donor plate together to prevent the flow of fluid between receiver wells. In some embodiments, the receiver plate may have any male or female structure that interacts with a corresponding female or male structure, respectively, on the transfer adapter to facilitate alignment, sealing, and/or coupling of the plates. For example, the receiver plate may comprise a lip around the perimeter of the contact surface, around the receiver well or wells, or at any other suitable location, and the lip may fit into a corresponding groove of the transfer adapter.

In some embodiments, in addition to coupling with a transfer adapter, a receiver plate may be configured to removably couple with a donor plate. For example, it may be advantageous for the receiver plate to also function as a lid for the donor plate. In other words, the receiver plate may be configured to reversibly attach to the donor plate such that the top surface of the donor plate is covered. In some embodiments, the receiver plate may be configured to be placed in a centrifuge. For example, the receiver plate may be shaped and sized to fit into a centrifuge (e.g., into a bucket of a centrifuge) and/or comprise a feature (e.g., clip or clamp) to reversibly attach to a portion of a centrifuge (e.g., to a bucket of a centrifuge). The receiver plate may comprise any suitable material or materials, including, but not limited to glass, plastic, and metal.

While the receiver plate is generally described as a separate and distinct element from the transfer adapter, it should be appreciated that in some embodiments, the receiver plate may be integrally formed with the transfer adapter. In these embodiments, the combined transfer adapter-receiver plate may couple with a donor plate to facilitate transfer of fluid from the wells of the donor plate and contain the transferred fluid. A combined transfer adapter-receiver plate may be configured to allow or prevent the mixing of fluid transferred from different wells of the donor plate.

### Transfer Systems and Kits

One or more elements of the transfer systems described here may be included in a transfer kit that may facilitate simultaneous and uniform transfer of fluid from the wells of a donor plate to the wells of a receiver plate. For example, in some embodiments, the transfer kit may comprise a donor plate, a transfer adapter, and a receiver plate. In other embodiments, the transfer kit may comprise a transfer adapter and a receiver plate, and the transfer kit may be configured for use with a standard, off-the-shelf multi-well plate. In embodiments where the transfer adapter and donor plate are integrally formed, the transfer kit may comprise a combined donor plate-transfer adapter. In embodiments where the transfer adapter and receiver plate are integrally formed, the transfer kit may comprise a combined transfer adapter-receiver plate. In some embodiments, the transfer kit may further comprise a separation well structure configured to be coupled with the donor plate. The separation well structure may be configured to be removably coupled with the donor plate. In some embodiments, the separation well structure is fixedly attached or integral to the donor plate. In some embodiments, the transfer kit may comprise the transfer adapter, and the transfer kit may be configured for use with standard multi-well plates for both the donor plate and the receiver plate. It should be appreciated that the transfer kit may be configured for use with a specific target agent, fluid, centrifuge, and/or type of standard multi-well plate.

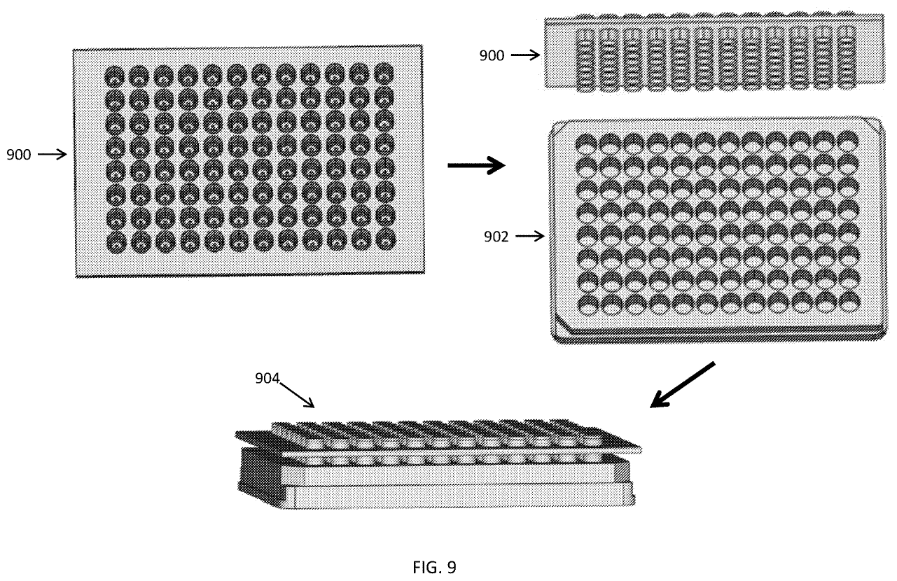

In some embodiments, the agent transfer system disclosed herein comprises a donor container for well-to-well transfer into a receiver container. In one aspect, the donor container is a donor plate comprising a structure that functions as a transfer adaptor as disclosed in any of the preceding embodiments. For example in some embodiments, the transfer adaptor structure of the donor plate is similar to the second extension (608) as shown in FIG. 6B; however in these embodiments, the primary extension (606) as shown in FIGS. 6A-6B now has a closed end—thus the transfer adaptor is configured to accommodate one or more agents and function as a donor plate. As shown in FIG. 9, one or more agents (not shown) may be pre-deposited (e.g., by a manufacturer) into a donor plate (900). In one aspect, the donor plate faces up when the one or more pre-deposited agents localize to the bottom of one or more closed ends (e.g., wells). In another aspect, the donor plate is configured to couple with a receiver plate (902) in order to form a transfer assembly (904). These examples use a 96-well plate format for purpose of illustration, but any well format (e.g., a 384-well plate format) may be used. In one aspect, the donor plate may be inverted while the receiver plate faces up in order to form the transfer assembly, as illustrated in FIG. 9. In another aspect, the receiver plate may be inverted while the donor plate faces up in order to form the transfer assembly. In other words, the donor plate may be mounted on top of the receiver plate, or vice versa, e.g., by inserting the transfer adaptor structure of the donor plate into one or more wells of a receiver container (e.g., a 96-well plate). This step may also be performed by a manufacturer.

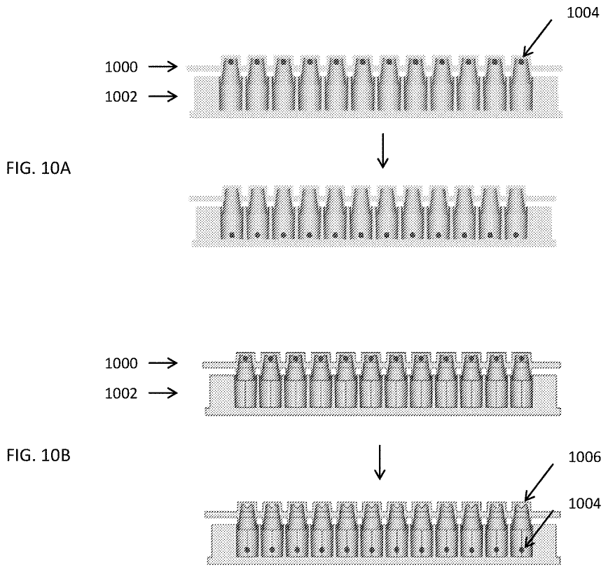

In one aspect, the transfer assembly may be subject to an external force, such as a centrifugal force, in order to transfer one or more agents from the donor container to the receiver container. An example is shown in FIG. 10A, where agent 1004 is pre-deposited in donor plate 1000, which is assembled onto receiver plate 1002. Once the assembly is placed in a centrifuge, agent 1004 may be transferred into the wells of receiver plate 1002.

In one aspect, provided herein is a device for transferring fluid, comprising: a planar sheet having a first planar surface on a first side and a second planar surface on a second side, a plurality of enclosures (e.g., wells) on the first side having openings on the second side, a plurality of extensions on the second side protruding from the second planar surface and comprising a lumen connected to the openings of the enclosures. In one embodiment, each extension is configured to be inserted into a different receiver well of a receiver plate. In another embodiment, an outer surface of each extension is configured to seal against a different receiver well of a receiver plate. In any of the preceding embodiments, an inner surface of the extension can be configured to form an angle with an inner wall of the receiver well, and the angle can be less than about 10 degrees, for example, about 1 degree, about 2 degrees, about 3 degrees, about 4 degrees, about 5 degrees, about 6 degrees, about 7 degrees, about 8 degrees, about 9 degrees, or about 10 degrees.

In another aspect, the donor plate comprises one or more structures or patterns to better retain and/or dispense an agent. For example, a protrusion may be provided in a well of the donor plate (e.g., at the bottom of the well) in order to accommodate the agent, such as a dried agent, e.g., a lyophilized agent. An example is shown in FIG. 10B, where agent 1004 is pre-deposited on protrusion 1006 in donor plate 1000, which is assembled onto receiver plate 1002. Once the assembly is placed in a centrifuge, agent 1004 may be transferred into the wells of receiver plate 1002. In this example, before the transfer (e.g., by centrifugation), protrusion 1006 may facilitate retention of agent 1004 in the donor plate. During the transfer, protrusion 1006 may help dispense agent 1004 into the receiver plate. Any suitable pattern of protrusions or the like may be used. For example, the donor plate may comprise a plurality of protrusions in one or more wells, each having a different agent pre-deposited thereon. The receiver plate may contain one or more solutions in the receiver wells. Once a transfer assembly is formed, material transfer can be performed to and/or from the receiver wells. For example, when a leak-proof seal is formed between a donor well and a receiver well, the solution in the receiver well can be mixed with the one or more agents on the plurality of protrusions of the donor well.

In some embodiments, a kit comprises a system for delivering materials or reagents for carrying out a method disclosed herein. In the context of reaction assays using the presently disclosed material transfer system, the kit may include systems that allow for the storage, transport, or delivery of reaction reagents (e.g., probes, enzymes, etc. in the appropriate containers) and/or supporting materials (e.g., buffers, written instructions for performing the assay etc.) from one location to another. For example, kits include one or more enclosures (e.g., boxes) containing the relevant reaction reagents and/or supporting materials. Such contents may be delivered to the intended recipient together or separately. For example, a first container may contain an enzyme for use in an assay, while a second container contains probes. In some embodiments, each component of the kit, for example, a donor plate, a transfer adaptor, and a receiver plate, may be packaged separately. In other embodiments, two or more components of the kit may be packaged together. For example, a donor plate, a transfer adaptor, and/or a receiver plate may be packaged together. Alternatively, a donor plate and a transfer adaptor may be packaged together, while a receiver plate is separately packaged or provided by a user of the kit.

### Methods

In one aspect, disclosed herein is a method to facilitate the transfer of a material (e.g., one or more fluids, and/or one or more dry reagents) to or from wells of a multi-well plate utilizing a fluid transfer force produced, for example, by gravity or a centrifuge.

In some embodiments, it is desirable to remove a fluid from a plurality of wells in a donor plate, and the method comprises transferring the fluid from the wells of the donor plate to a receiver plate.

In some embodiments, it is desirable to add a fluid to a plurality of wells in a receiver plate, and the method comprises first adding the fluid to a donor plate, followed by transferring the fluid from the donor plate to the wells of the receiver plate.

In any of the preceding embodiments, the donor plate may have features that allow for simultaneous loading of the fluid into a plurality of wells in the donor plate. The fluid may be simultaneously transferred from every well of the donor plate, and the effect of the fluid transfer force may be substantially uniform within each well and between different wells. In addition, fluid transfer may be predominantly automatic, and minimal manual work may be required. The methods may generally comprise forming a transfer assembly from the donor plate, a transfer adapter, and a receiver plate, and centrifuging the transfer assembly. Forming the transfer assembly may comprise removably coupling a first side of the transfer adapter with the donor plate and removably coupling a second, opposite side of the transfer adapter with the receiver plate. Coupling the transfer adapter and the donor plate may involve aligning each opening of the transfer adapter with a different well of the donor plate and forming a fluid-tight seal between the transfer adapter and donor plate. Similarly, in embodiments of transfer systems comprising a receiver plate with a plurality of receiver wells, coupling the transfer adapter and the receiver plate may involve aligning each opening of the transfer adapter with a different receiver well of the receiver plate and forming a fluid-tight seal between the transfer adapter and receiver plate. In some embodiments, the donor plate and transfer adapter are integrally formed, and forming the transfer assembly may comprise removably coupling an exposed side of the transfer adapter of a combined donor plate-transfer adapter with the receiver plate. In some embodiments, the transfer adapter and donor plate are integrally formed, and forming the transfer assembly may comprise removably coupling an exposed side of the transfer adapter of a combined transfer adapter-receiver plate with the donor plate.

The transfer assembly may be in a first position when it is formed. In the first position, the transfer adapter may be positioned below the receiver plate and above the donor plate. In this position, fluid may remain in the wells of the donor plate. In some embodiments, such as a transfer assembly comprising the donor plate 300 of FIG. 3, in the first position the transfer adapter may be positioned below the donor plate and above the receiver plate, and in this position fluid may remain in the wells of the donor plate. After the transfer assembly is formed, it may be centrifuged around an axis of rotation. The centrifuge may produce a fluid transfer force, which may cause movement of fluid away from the axis of rotation. The transfer assembly may therefore be oriented in the centrifuge so that when the centrifuge spins, the outward movement of fluid may result in fluid flow from the donor plate to the receiver plate. This may be accomplished by orienting the transfer assembly such that the donor plate is closer to the axis of rotation than the transfer adapter and receiver plate. The specific orientation of the transfer assembly (e.g., the angle of the transfer assembly relative to the axis of rotation) when the centrifuge is at rest and when it spins may depend at least on the type of centrifuge rotor that is used. The transfer assembly may be centrifuged for a desired duration and at a desired speed to control the amount and/or rate of fluid transfer. After the transfer assembly is centrifuged, the donor plate, transfer adapter, and receiver plate may be separated, which may, for example, allow the transferred fluid and/or isolated target agents to be accessed.

### Forming a Transfer Assembly

In some embodiments of the methods described herein, the donor plate does not contain a fluid, and the method comprises delivering a fluid to the donor plate. Referring to the embodiments of donor plate 300, a fluid (e.g., an aqueous composition) may be delivered to a holding cavity (e.g., holding cavity 350 described above) of the donor plate. The holding cavity may be formed by coupling a boundary wall (e.g., boundary wall 302 described above) to a transfer adapter (e.g., transfer adapter 700 described above). In some embodiments, the boundary wall is fixedly attached or integral to the transfer adapter. A separation well structure (e.g., separation well structure 400 described above) may be coupled within the holding cavity, which may divide the contents of the holding cavity into a plurality of separation wells (e.g., separation wells 408 described above). In some embodiments, the separation well structure is configured to be removably coupled within the holding cavity, and the fluid is delivered to the holding cavity prior to coupling the separation well structure within the holding cavity. In some embodiments, the fluid is delivered to the holding cavity after coupling the separation well structure within the holding cavity. In some embodiments, the separation well structure is fixedly attached or integral to the boundary wall and/or transfer adapter. In some embodiments where the fluid is delivered to a holding cavity having a separation well structure therewithin, the separation well structure may comprise one or more separation wall slots (e.g., separation wall slots 440 as described above) such that two or more of the separation wells is fluidly connected, and delivering the fluid to the holding cavity comprises delivering the fluid to one or more separation wells. In some embodiments, a period of time may be allowed for an equal volume of the fluid to distribute to each of the separation wells that are fluidly connected.

In some embodiments, a transfer assembly may be formed by coupling at least one receiver plate with a donor plate comprising a plurality of wells filled with fluid, optionally wherein wells of the donor plate and/or receiver plate contain one or more target agents. For example, a first side of a transfer adapter may be coupled with the donor plate (e.g., removably, fixedly, or integrally), and a second, opposite side of the transfer adapter may be coupled with a receiver plate. In one aspect, the donor plate may be directly coupled with the transfer adapter and indirectly coupled with the receiver plate. Coupling the donor plate, transfer adapter, and receiver plate to form a transfer assembly may allow fluid from the wells of the donor plate to be transferred through openings in the transfer adapter and into the receiver plate. The donor plate, transfer adapter, and receiver plate may be coupled in any sequential order. In other words, the donor plate may be attached to the first side of the transfer adapter before, after, or at the same time that the receiver plate is attached to the second side of the transfer adapter. The coupling or attachment between the transfer adapter and the donor and/or receiver plates may be irreversible or reversible. Reversible coupling of the transfer adapter with the donor and/or receiver plates may allow the plates to be uncoupled and separated, which may, for example, allow the transferred fluid and/or isolated target agents to be accessed after transfer.

Coupling a transfer adapter and a donor plate may comprise aligning the transfer adapter and donor plate and sealing them together. Aligning the transfer adapter and the donor plate may comprise aligning the openings of the transfer adapter with the wells of the donor plate. This alignment may be facilitated by one or more features of the transfer adapter and/or donor plate. For example, in embodiments of transfer adapters that comprise a primary extension associated with each opening, each primary extension may be inserted into a different well of the donor plate, thereby aligning each opening with a different well. In embodiments of transfer adapters that comprise an alignment guide, the alignment guide may be aligned with a predetermined portion of the donor plate, which may also align the openings of the transfer adapter with the wells of the donor plate.

Coupling the transfer adapter and the donor plate may also comprise forming a fluid-tight seal between the two plates. The seal or seals may block fluid from flowing between different wells of the donor plate, but may still allow fluid to flow out of the wells and through the openings in the transfer adapter. The sealing may be facilitated by one or more features of the transfer adapter and/or donor plate. In some embodiments, these one or more features may be the same as the one or more features that facilitate alignment. For example, in embodiments of transfer adapters comprising a primary extension associated with each opening, each primary extension may form a seal with a different well of the donor plate in addition to facilitating alignment. Each primary extension may be inserted into a well and advanced until a portion of the exterior surface of the primary extension seals against a portion of the interior surface of the well. In some embodiments, the one or more features that facilitate sealing may be different than the one or more features that facilitate alignment. For example, some embodiments of transfer adapters may comprise a first surface that is at least partially covered with an adhesive. In this embodiments, the adhesive-covered, first surface of the transfer adapter may be pressed against a top surface of the donor plate to form a seal that may block fluid from flowing between different wells. In some embodiments, the transfer adapter is fixedly attached or integral to the donor plate. It should be appreciated that in embodiments in which the transfer adapter and donor plate are integrally formed, the method of forming a transfer assembly may not comprise coupling the transfer adapter and donor plate.

Forming the transfer assembly may also comprise coupling the transfer adapter and a receiver plate. Coupling the transfer adapter and the receiver plate may comprise aligning the transfer adapter and receiver plate and sealing them together. In embodiments of transfer assemblies that comprise a receiver plate with a plurality of receiver wells, the methods of aligning and/or sealing the transfer adapter and receiver plate may be similar to the methods described for aligning and/or sealing the transfer adapter and donor plate. For example, aligning the transfer adapter and the receiver plate may comprise aligning the openings of the transfer adapter with the receiver wells of the receiver plate. Sealing the transfer adapter and receiver plate together may form fluid-tight seals between the receiver wells and the transfer adapter, which may allow fluid to flow through the openings and into the receiver wells, but may prevent fluid from flowing between receiver wells. These seals may also help to ensure that fluid from each well of the donor plate flows into a different receiver well of the receiver plate. It should be appreciated that in some embodiments, coupling the transfer adapter and receiver plate may comprise aligning each opening with a different receiver well, but fluid-tight seals may not be formed. One or more features of the transfer adapter and/or receiver plate may facilitate the alignment and/or sealing of the transfer adapter and receiver plate, such as secondary extensions and/or an adhesive on a second side of the transfer adapter. In some embodiments, the transfer adapter is fixedly attached or integral to the receiver plate.

In embodiments of transfer assemblies that comprise a receiver plate with fewer receiver wells than there are openings in the transfer adapter, the coupling of transfer adapter and receiver plate may still comprise alignment and/or sealing. For example, when a transfer adapter comprising a plurality of openings is coupled with a receiver plate comprising a single receiver well, alignment may align all openings with the single receiver well so that all transferred fluid may be contained in the receiver well. In addition, a fluid-tight seal between the transfer adapter and the receiver plate may be formed around the single receiver well in order to prevent the escape of fluid out of the transfer assembly. It should also be appreciated that in embodiments in which the transfer adapter and receiver plate are integrally formed, the method of forming a transfer assembly may not comprise coupling the transfer adapter and receiver plate.

In some embodiments, the transfer assembly may be assembled in a first, upright position as shown in FIG. 1B, with the donor plate in an upright position, e.g., with the openings of the wells facing upwards. FIG. 1B shows an example of a transfer assembly (102) in a first, upright position. As seen there, transfer adapter 106 is positioned below receiver plate 108 and above donor plate 104. The openings of the wells (not shown) of the donor plate are facing upwards and towards the transfer adapter. The receiver plate is inverted, e.g., the inlets of the receiver wells are facing downwards toward the transfer adapter. In this position the fluid may remain in the wells of the donor plate due to gravity.

Referring to the embodiments of the transfer assembly (152) shown in FIG. 1D, the transfer assembly may be assembled in a first position, with transfer adapter 156 positioned below donor plate 154 and above receiver plate 158. The donor plate is in an upright position, e.g., with the top openings of the wells facing upwards and the bottom openings of the wells (not shown) facing downwards and toward the transfer adapter. The receiver plate is upright, e.g., the inlets of the receiver wells are facing upwards toward the transfer adapter. In this position the fluid may remain in the wells of the donor plate due to the properties of the transfer adapter and/or the fluid. In some embodiments, the donor plate is fixedly attached or integral to the transfer adapter. In some embodiments, the donor plate is the donor plate (e.g., 300), and comprises a separation well structure (e.g., 400) coupled thereto. In some embodiments, the separation well structure is configured to be removably coupled to the donor plate, and assembling the transfer assembly further comprises coupling the separation well structure to the donor plate. In some embodiments, the separation well structure is fixedly attached or integral to the donor plate.

### Material Transfer

After a transfer assembly has been formed in a first position, the transfer assembly may be repositioned to allow gravity and/or an external force to transfer fluid from the donor plate to the receiver plate. For example, in some embodiments of the methods described here, the transfer assembly may be placed in a centrifuge, and the centrifuge may generate a fluid transfer force. The fluid transfer force may have a substantially simultaneous and uniform effect on the fluid and any target agents within each well and in different wells. In embodiments of transfer assemblies in which fluid does not flow from the donor plate to the receiver plate under the force of gravity, centrifuging the transfer assembly may cause fluid to flow from the donor plate to the receiver plate. In embodiments of transfer assemblies in which fluid does flow from the donor plate to the receiver plate under the force of gravity, centrifuging the transfer assembly may cause fluid to flow more quickly and/or may allow for more complete transfer of fluid from the donor plate.

The centrifuge may comprise a rotor that spins around an axis of rotation, and the transfer assembly may be placed in or on the rotor to also spin around the axis of rotation. The spinning motion of the transfer assembly may cause fluid to move outward, away from the axis of rotation. The transfer assembly may be oriented in the centrifuge in such a way that outward movement of the fluid may result in flow out of the wells of the donor plate, through openings of the transfer adapter, and into the receiver plate. For example, when the centrifuge spins, e.g., when the centrifuge rotor and the transfer assembly spin around an axis of rotation, the transfer assembly may be oriented such that the donor plate is positioned closer to the axis of rotation than the transfer adapter and receiver plate. More specifically, when the centrifuge spins, each well of the donor plate may be positioned closer to the axis of rotation than the opening of the transfer adapter and the receiver well with which it is aligned.

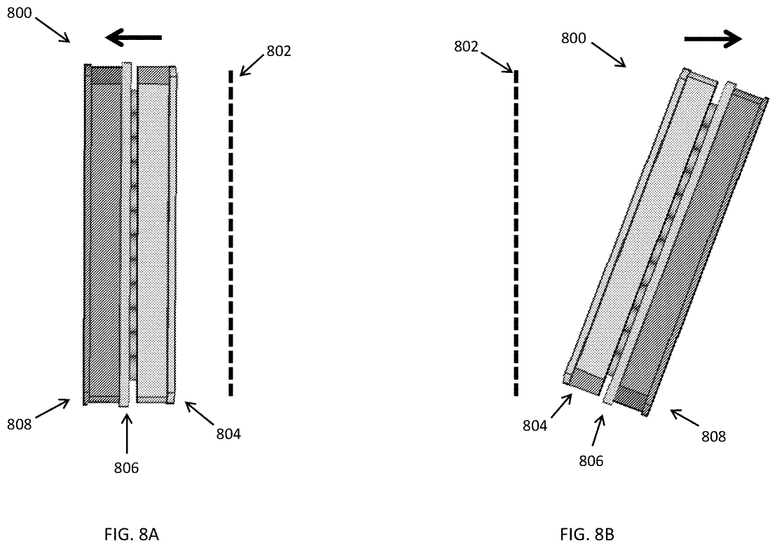

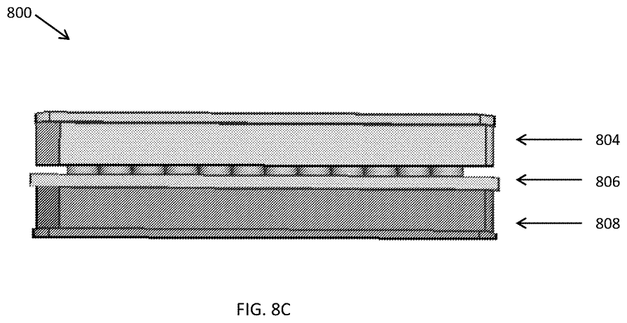

In some embodiments, as seen in FIG. 8A, when the centrifuge spins, the transfer assembly (800) may be oriented parallel to the axis of rotation (802). In other embodiments, as seen in FIG. 8B, when the centrifuge spins, the transfer assembly may be oriented at an angle between parallel and perpendicular to the axis of rotation. However, as seen in both FIGS. 8A and 8B, when the centrifuge spins, the donor plate (804) may be closer to the axis of rotation than the transfer adapter (806) and the receiver plate (808).

The specific orientation of a transfer assembly when it is in a centrifuge may depend on the type of centrifuge rotor used. For example, when a fixed angle rotor is used, the transfer assembly may have the same orientation when it is initially placed in the centrifuge and the centrifuge is at rest as it does when the centrifuge spins (e.g., vertical, angled between vertical and horizontal). In contrast, when a swinging bucket rotor is used, the transfer assembly may have a different orientation when it is initially placed in the centrifuge than it does when the centrifuge spins. For example, when the transfer assembly is initially placed in a centrifuge with a swinging bucket rotor, the transfer assembly may be oriented horizontally (e.g., perpendicular to the axis of rotation). When the centrifuge spins, the buckets of the rotor and the transfer assembly may tilt outwards to orient the transfer assembly such that the donor plate is closer to the axis of rotation than the transfer adapter and receiver plate. It should be appreciated that when the transfer assembly is initially placed horizontally into a centrifuge, the transfer assembly may be inverted compared to its orientation when assembled in the first, upright position. For example, as shown in FIG. 8C, when the transfer assembly (800) is in a second, inverted position, the transfer adapter (806) may be below the donor plate (804) and above the receiver plate (808).

In one aspect, after the transfer assembly is placed into the centrifuge, the centrifuge rotor may spin to produce a fluid transfer force. The fluid transfer force may cause fluid to flow outwards from the donor plate to the receiver plate, but target agents may remain attached to wells of the donor plate and/or receiver plate. The specific centrifuging methods may depend on characteristics of the transfer assembly (e.g., the embodiments of the donor plate, and/or the embodiments of the transfer adapter), the fluid to be transferred (e.g., the quantity and/or the viscosity), and any target agents (e.g., the attachment of target agents to the wells, and/or the stability of the target agents). Based on at least these characteristics, the transfer assembly may be centrifuged for a desired duration and with desired centrifuge settings. For example, the velocity (e.g., rotations per minute), acceleration, temperature, distance from the axis of rotation, type of rotor, and/or any other available settings may be specified in order to remove fluid from a certain transfer assembly. Settings such as these may be adjusted in order to increase the chances that substantially all fluid is transferred from the wells of the donor plate, decrease the chances that any target agents are detached from the wells or damaged, and/or determine the time required to remove the fluid from the wells.

As mentioned above, a fluid transfer force produced by a centrifuge may differently affect different embodiments of transfer assemblies. For example, when some embodiments of transfer assemblies are placed in the centrifuge, the fluid transfer force may start the flow of fluid out of wells of a donor plate. In other embodiments, fluid may have started flowing out of the wells due to the force of gravity before the fluid transfer force from the centrifuge is applied to the transfer assembly. Applying a fluid transfer force to these embodiments of transfer assemblies may result in an increase in the flow of fluid (e.g., volumetric flow rate and/or flow velocity) out of the wells of the donor plate until substantially all fluid has been transferred from the donor plate to the receiver plate. When the fluid transfer force is applied to certain embodiments of transfer assemblies, the size and/or shape of the openings of the transfer adapter may change. For example, when the fluid transfer force is applied to a transfer assembly comprising a transfer adapter with one or more leaflets around each opening, at least a portion of the one or more leaflets may deflect out of the plane of the transfer adapter planar sheet and away from the axis of rotation. Movement of the transfer adapter leaflets may increase the size of the openings, thereby allowing an increased flow of fluid through the openings. Thus, while the specific effects of the fluid transfer force may depend on the embodiments of the transfer assembly, the overall effect may be to increase the amount or rate of fluid transfer from the wells of the donor plate to the receiver plate.

When a transfer assembly is centrifuged, substantially all fluid and any target agents in the transfer assembly may experience the effects of a fluid transfer force at the same time. This is in contrast to other fluid transfer techniques, such as pipetting individual wells or a subset of the wells, where the fluid transfer force may affect the fluid and any target agents in some wells before others. Transferring the fluid from all of the wells of a donor plate simultaneously may have one or more advantages, such as increasing the speed of fluid transfer and decreasing the variability between the reactions, binding, or other processes occurring in different wells. This may be desirable, for example, when processes are time-sensitive. In addition, the effect of the fluid transfer force may be substantially uniform within each well and between different wells. Thus, the fluid and any target agents within each well and in different wells may experience approximately the same fluid transfer force, which may decrease the variability between samples from different portions of the same well and between samples from different wells. In contrast, when a pipette is used to remove fluid from a well, the forces near the tip of the pipette may be different than the forces farther from the tip, and it may be difficult to apply the same force to different wells. It should be appreciated that while the effects of the fluid transfer force produced by a centrifuge may be substantially uniform, there may be negligible embodiments within wells and between wells due to slight differences in the distance from the axis of rotation. However, these differences may have negligible effects on the fluid, target agents, and/or processes (e.g., reactions, binding, or the like) occurring in the wells.

In some embodiments of the methods described here, a transfer assembly may not be placed in a centrifuge. For example, as described in detail above, some embodiments of transfer adapters may be configured to allow fluid to flow from the donor plate to the receiver plate under the force of gravity. In one aspect, flipping the transfer assembly from a first, upright position to a second, inverted position may result in the transfer of fluid. Referring to FIG. 8C, when a transfer assembly (800) is a second, inverted position, the transfer adapter (806) is below the donor plate (804) and above the receiver plate (802). In this orientation, the donor plate may be in an inverted position such that openings of the wells (not shown) are facing downwards and towards the transfer adapter. The receiver plate (808) may be in an upright position such that the receiver well inlets (not shown) are facing upwards towards the transfer adapter. The transfer assembly may remain in the second, inverted position for a desired duration, which may be sufficient to remove substantially all of the fluid from the wells of the donor plate. The desired duration may be determined by at least characteristics of the transfer assembly (e.g., the embodiments of the donor plate, and/or the embodiments of the transfer adapter), the fluid to be transferred (e.g., the quantity, and/or the viscosity), and any target agents (e.g., the attachment of the target agents to the wells, and/or the stability of the target agents). Furthermore, it should be appreciated that in other embodiments of the methods described here, the transfer assembly may be flipped from a first, upright position to a second inverted position, which may result in transfer of fluid, and then the transfer assembly may be subsequently centrifuged as described above.

### Separating a Transfer Assembly

In embodiments in which the transfer assembly is centrifuged, after centrifuging, the transfer assembly may be removed from the centrifuge, and one or both of the plates may be separated. In embodiments of the methods that do not comprise centrifuging, one or both of the plates of the transfer assembly may be separated after the transfer assembly has been in a second, inverted position for a desired duration. In some embodiments, the donor plate, transfer adapter, and receiver plate may be separated. The donor plate, transfer adapter, and receiver plate may be separated from each other in any order, and this separation may allow target agents in the donor plate and/or the transferred fluid in the receiver plate to be accessed. Studies may then be performed on the isolated target agents and/or transferred fluid, or the target agents or transferred fluid may be discarded. In some embodiments, the transfer assembly may be reformed and inverted and/or centrifuged again if, for example, it is determined that some fluid remains in the wells of the donor plate. In other embodiments, the donor plate may be separated from the transfer adapter, while the transfer adapter and receiver plate remain coupled. In yet other embodiments, the receiver plate may be separated from the transfer adapter, while the donor plate and the transfer adapter remain coupled.

Although the foregoing invention has, for the purposes of clarity and understanding, been described in some detail by way of illustration and example, it will be apparent that certain changes and modifications may be practiced, and are intended to fall within the scope of the appended claims. Additionally, it should be understood that the components and characteristics of the devices described herein may be used in any combination and the description of the certain elements or characteristics with respect to a specific figure are not intended to be limiting or suggest that the element cannot be used in combination with any of the other described elements.

### EXAMPLES

### Example #1

As one example, the methods described herein could be used to study a drug's pathway.

1. Cell Introduction: A cell suspension may be pipetted into the wells of a 96-well multi-well plate filled with cell culture media. The cells may then be allowed to attach to the bottom surface of the wells for a certain amount of time.

2. Collection of conditioned media: After the cells reach the desired condition, a transfer assembly may be formed by coupling a first surface of a transfer adapter (such as a transfer adapter with 96 openings) to the top of the 96-well multi-well plate (here, donor plate) in an upright position, and coupling an inverted receiver plate having one well to the second surface of the transfer adapter, such that the openings of the transfer adapter align with the wells of the 96-well multi-well plate. The transfer assembly may be inverted, loaded into a swing bucket rotor, and centrifuged using conditions that allow for about half of the conditioned media to transfer from the donor plate to the receiver plate without substantially disturbing the attached cells. The receiver plate may be decoupled from the transfer assembly and the conditioned media reserved. The remaining transfer adapter-96-well multi-well plate assembly may be inverted such that the 96-well multi-well plate is upright, and optionally centrifuged using parameters that allow for collection of any remaining media into the bottom of the wells without disturbing the attached cells, and the transfer adapter may be decoupled from the 96-well multi-well plate.

3. Treatment: A testing condition may be imposed onto the cells. For example, a combination donor plate-transfer adapter having openings at the top and bottom surfaces of the donor plate may be coupled to the 96-well multi-well plate containing the cells to be treated (here, receiver plate) by coupling the exposed transfer adapter surface of the donor plate-transfer adapter to the top of the 96-well multi-well plate in an upright position, thereby forming a transfer assembly. In one aspect, the holding cavity of the donor plate does not have a separation well structure coupled therewithin prior to loading with fluid. A testing agent, such as a drug at a desired concentration, may be added to the reserved conditioned media, which is loaded into the holding cavity of the donor plate. A separation well structure may then be coupled within the holding cavity, such that the fluid in the holding cavity is divided into 96 separation wells that align with the openings in the transfer adapter and the wells of the 96-well multi-well plate. Coupling of the separation well structure within the holding cavity may result in the volume of fluid in each of the separation wells being evenly distributed.

For example, a separation well structure may be coupled within the holding cavity prior to loading of a testing agent diluted in conditioned media. As another example, the separation well structure may comprise one or more separation wall slots or gaps that fluidly connect two or more of the separation wells, and the testing agent diluted in conditioned media may be loaded into one or more separation wells, allowing for the media to be equally distributed among the fluidly connected separation wells.

For example, the separation well structure may be configured such that each of the separation wells are fluidly connected with one another, and a composition comprising the conditioned media supplemented with a testing agent may be delivered to one or more of the separation wells such that the composition is evenly distributed between each of the separation wells.

For example, the separation well structure may be configured such that a first subset (such as a first half) of the separation wells are fluidly connected with each other and a second subset (such as a second half) of the separation wells are fluidly connected with each other, but the first subset of the separation wells are not fluidly connected with the second subset of the separation wells. In such an example, a first composition comprising a portion of the conditioned media supplemented with one concentration of a testing agent may be delivered to one or more wells of the first subset of the separation wells, such that the first composition is evenly distributed between each of the first subset of the separation wells, and a second composition comprising another portion of the conditioned media supplemented with a different concentration of the testing agent (or a different testing agent) may be delivered to one or more wells of the second subset of the separation wells, such that the second composition is evenly distributed between each of the second subset of the separation wells.

The fluid in the donor plate may be transferred to the 96-well multi-well plate containing the cells to be treated by centrifuging the transfer assembly under conditions that allow the fluid to pass from the separation wells of the donor plate, through the openings in the transfer adapter, and into the wells of the 96-well multi-well plate without substantially disturbing the cells attached thereto.

4. Collection of media: After the testing condition matures, the media of each well may be collected into individual wells of a receiver plate for analysis, such as for the presence of secreted factors. A transfer assembly may be formed as described above in step 2, but with a receiver plate having 96 wells that align with the openings of the transfer adapter and the wells of the 96-well multi-well plate containing the attached cells. The transfer assembly may be centrifuged under conditions that allow for transfer of the fluid from the 96-well multi-well plate to the receiver plate without substantially disturbing the attached cells. The recovered media in the receiver plate may then be analyzed.

5. Cell preparation: Various markers of the cells can be screened. Cells may first be prepared for analysis. The cells may be washed with phosphate buffered saline by assembling a transfer assembly as described above in step 3, where the phosphate buffered saline is loaded into the holding cavity of the donor plate and the transfer assembly is centrifuged under conditions that allow the phosphate buffered saline to transfer into the wells of the 96-well multi-well plate without substantially disturbing the attached cells. The phosphate buffered saline may then be removed from the wells of the 96-well multi-well plate by uncoupling the 96-well multi-well plate from the transfer assembly, forming a transfer assembly as described above in step 2, and centrifuging the transfer assembly under conditions that allow for the phosphate buffered saline to transfer to the receiver plate without substantially disturbing the attached cells. Similar methods of loading fluid to and removing fluid from the wells of the 96-well multi-well plate can be applied to fix cells in the 96-well multi-well plate with formalin or paraformaldehyde solutions by loading, incubating, and removing the solutions. The cells may then be washed with phosphate buffered saline, blocked by serum or albumin solutions, if necessary permeablized by Triton X-100, and then immersed in phosphate buffered saline using the methods described above.

6. Analytic Agent Introduction: One or more analytic agents (e.g., primary antibody) may then be delivered using, for example, a method similar to the method described above in step 3 for delivering a fluid to the wells of the 96-well multi-well plate. Adequate time for incubation may be allowed so that the analytic agents such as primary antibodies may attach to their targets.

7. Detection Agent Introduction: After washing with phosphate buffered saline using, for example, a method similar to the method described above in step 5, the activity of the analytic agents, such as the primary antibody, may be analyzed. For example, if a non-conjugated primary antibody is used, the phosphate buffered saline may be replaced with a secondary antibody.

### Example #2

As another example, the methods described herein could be used to for assessing the efficacy of a drug on multiple cell types from an individual (e.g., a patient).

1. Cell Introduction: A library of cells from an individual may be pipetted into individual wells of a 96-well multi-well plate. The cells may then be allowed to attach to the bottom surface of the wells for a certain amount of time.

2. Drug Loading: A combination donor plate-transfer adapter having openings at the top and bottom surfaces of the donor plate may be coupled to the 96-well multi-well plate containing the cells to be treated (here, receiver plate) by coupling the exposed transfer adapter surface of the donor plate-transfer adapter to the top of the 96-well multi-well plate in an upright position, thereby forming a transfer assembly. In some cases, the holding cavity of the donor plate does not have a separation well structure coupled therewithin prior to loading with fluid. A composition comprising a drug at a desired concentration may be loaded into the holding cavity of the donor plate. A separation well structure may then be coupled within the holding cavity, such that the fluid in the holding cavity is divided into 96 separation wells that align with the openings in the transfer adapter and the wells of the 96-well multi-well plate. Coupling of the separation well structure within the holding cavity may result in the volume of fluid in each of the separation wells being evenly distributed.

For example, a separation well structure may be coupled within the holding cavity prior to loading of a drug composition. The separation well structure may comprise one or more separation wall slots or gaps that fluidly connect two or more of the separation wells, and the drug composition may be loaded into one or more separation wells, allowing for the composition to be equally distributed among the fluidly connected separation wells.

For example, the separation well structure may be configured such that each of the separation wells are fluidly connected with one another, and a composition comprising the drug may be delivered to one or more of the separation wells such that the composition is evenly distributed between each of the separation wells.

For example, the separation well structure may be configured such that a first subset (such as a first half) of the separation wells are fluidly connected with each other and a second subset (such as a second half) of the separation wells are fluidly connected with each other, but the first subset of the separation wells are not fluidly connected with the second subset of the separation wells. In such an example, a first composition comprising one concentration of a drug may be delivered to one or more wells of the first subset of the separation wells, such that the first composition is evenly distributed between each of the first subset of the separation wells, and a second composition comprising a different concentration of the drug (or a different drug) may be delivered to one or more wells of the second subset of the separation wells, such that the second composition is evenly distributed between each of the second subset of the separation wells.

The fluid in the donor plate may be transferred to the 96-well multi-well plate containing the cells to be treated by centrifuging the transfer assembly under conditions that allow the fluid to pass from the separation wells of the donor plate, through the openings in the transfer adapter, and into the wells of the 96-well multi-well plate without substantially disturbing the cells attached thereto.

3. Analysis: The effect of the drug on the cells in each well may be analyzed through live cell analysis. Bright field images or videos of the cells in each well may be acquired. If the cells are intrinsically fluorescent (e.g., due to a GFP gene transfected into the cells' genome), fluorescent images of the cells may be acquired. Additionally or alternatively, the media in each separation well may be reserved for further testing using, for example, methods similar to those described above in Example 1.

To observe the specific activities of the cells in response to the drug, the media in each well may be removed, and various assays may be performed on the cells using methods similar to those described above in Example 1. For example, in a staining assay, all the cells in the 96-well multi-well plate may be processed and stained at once, without the need for a robotic liquid handler or a multi-channel pipette. In a fluorescent assay, the fluorescent signals from the cells may be acquired.

1. A device for transferring fluid, comprising:
a planar sheet having a first planar surface, a second planar surface, and a plurality of openings, wherein each opening of the plurality of openings extends between the first planar surface and the second planar surface;
a plurality of primary extensions, wherein each primary extension of the plurality of primary extensions protrudes from the first planar surface and comprises a primary lumen; and
a plurality of secondary extensions, wherein each secondary extension of the plurality of secondary extensions protrudes from the second planar surface and comprises a secondary lumen, and wherein each secondary lumen is aligned with an opening and a primary lumen to create a continuous transfer lumen.

2. The device of claim 1, wherein each primary extension of the plurality of primary extensions has an inner cross-sectional area and an outer cross-sectional area, and wherein the inner cross-sectional area is greater than the outer cross-sectional area.

3. The device of claim 1 or 2, wherein each primary extension has at least two regions, and wherein each of the at least two regions has a different angle relative to the planar sheet.

4. The device of claim 3, wherein the at least two regions comprise a first region proximal to the planar sheet and a second region distal to the planar sheet, and the angle of the first region relative to the planar sheet is greater than the angle of the second region relative to the planar sheet.

5. The device of any one of claims 1-4, wherein each primary extension of the plurality of primary extensions comprises at least one structure configured to fluidly connect to the primary lumen.

6. The device of claim 5, wherein the at least one structure comprises an aperture, a hole, a slit, a gap, a notch, a grove, or a channel.

7. The device of claim 6, wherein the primary extension comprises four slits configured to fluidly connect to the primary lumen.

8. A system for transferring fluid, comprising:
a transfer adapter, wherein the transfer adapter comprises a first side, a second side, and a plurality of openings, and wherein each opening of the plurality of openings extends between the first side and the second side; and
a receiver plate, wherein the receiver plate is configured to removably couple to the second side of the transfer adapter.

9. The system of claim 8, further comprising a donor plate comprising one well or a plurality of wells, wherein the donor plate is configured to removably couple to the first side of the transfer adapter.

10. The system of claim 9, wherein each opening of the plurality of openings aligns with a different well of the plurality of wells when the transfer adapter and the donor plate are removably coupled.

11. The system of claim 9 or 10, wherein the transfer adapter comprises a plurality of primary extensions, and wherein each primary extension of the plurality of primary extensions is configured to seal against an interior surface of a different well of the plurality of wells of the donor plate.

12. The system of any one of claims 8-11, wherein the receiver plate comprises a plurality of receiver wells, and wherein each opening of the plurality of openings aligns with a different receiver well of the plurality of receiver wells when the transfer adapter and the receiver plate are removably coupled.

13. The system of any one of claims 8-12, wherein the transfer adapter comprises a plurality of secondary extensions, and wherein each secondary extension of the plurality of secondary extensions is configured to be inserted into a different receiver well of the plurality of receiver wells.

14. The system of any one of claims 8-13, wherein the transfer adapter comprises an adhesive on the first side and/or the second side.

15. The system of any one of claims 8-14, wherein the transfer adapter comprises a plurality of leaflets adjacent to each opening of the plurality of openings, wherein at least one leaflet is moveable between an open position and a closed position.

16. The system of any one of claims 8-15, wherein the transfer adapter is configured to allow the flow of a fluid through the plurality of openings only when an external force is applied to the fluid.

17. A method for transferring fluid, comprising:
coupling a transfer adapter, a donor plate, and a receiver plate to form a transfer assembly in a first position (e.g., an upright position), wherein in the first position the transfer adapter is positioned below the receiver plate and above the donor plate; and
centrifuging the transfer assembly around an axis of rotation, wherein when the transfer assembly is centrifuged, the donor plate is positioned closer to the axis of rotation than the transfer adapter and the receiver plate,
wherein the transfer adapter comprises a plurality of openings and the donor plate comprises a plurality of wells, and wherein each opening of the plurality of openings is aligned with a different well of the plurality of wells when the transfer assembly is in the first position and when the transfer assembly is centrifuged.

18. The method of claim 17, further comprising uncoupling the donor plate from the transfer adapter.

19. The method of claim 17 or 18, wherein a seal is formed between each well of the plurality of wells and the transfer adapter when the donor plate and the transfer adapter are coupled.

20. The method of claim 19, wherein the seal allows fluid to flow from the plurality of wells through the plurality of openings but blocks the flow of fluid between wells of the plurality of wells.

21. The method of any one of claims 17-20, wherein each well of the plurality of wells comprises a target agent attached the well and a fluid.

22. The method of claim 21, wherein the target agent remains attached to the well after centrifuging.

23. The method of claim 21 or 22, wherein the fluid is transferred to the receiver plate after centrifuging.

24. The method of any one of claims 17-23, wherein the receiver plate comprises a plurality of receiver wells, and wherein each opening of the plurality of openings is aligned with a different receiver well of the plurality of receiver wells when the transfer assembly is in the first position and when the transfer assembly is centrifuged.

25. The method of claim 24, wherein a seal is formed between each receiver well of the plurality of receiver wells and the transfer adapter when the receiver plate and the transfer adapter are coupled.

26. The method of claim 25, wherein the seal allows fluid to flow through the plurality of openings to the plurality of receiver wells but blocks the flow of fluid between receiver wells of the plurality of receiver wells.

27. A method for transferring fluid from and/or to wells of a donor plate comprising a plurality of wells, wherein at least one well comprises a plurality of target agents attached to the well and a fluid, comprising: applying a fluid transfer force to the donor plate, wherein the fluid transfer force has a simultaneous and substantially uniform effect on the plurality of target agents in the at least one well.

28. The method of claim 27, wherein each of at least two wells of the plurality of wells comprises a plurality of target agents attached to the well and a fluid, and wherein the fluid transfer force has a simultaneous and substantially uniform effect on the plurality of target agents in every well of the at least two wells.

29. A device for transferring fluid, comprising:
a planar sheet having a first planar surface on a first side and a second planar surface on a second side,
a plurality of enclosures (e.g., wells) on the first side having openings on the second side,
a plurality of extensions on the second side protruding from the second planar surface and comprising a lumen connected to the openings of the enclosures.

30. The device of claim 29, wherein each extension is configured to be inserted into a different receiver well of a receiver plate.

31. The device of claim 29, wherein each extension is configured to seal against a different receiver well of a receiver plate.

32. The device of any one of claims 29-31, wherein an inner surface of the extension is configured to form an angle with an inner wall of the receiver well, and the angle is about 7 degrees or less.

33. The device of any one of claims 29-32, further comprising an agent in the plurality of enclosures, such as a liquid agent, e.g., a lyophilized agent.

34. The device of any one of claims 29-33, wherein each enclosure comprises a structure configured to retain and/or dispense an agent.

35. The device of claim 34, wherein the structure comprises a protrusion.

36. A method for transferring an agent, comprising:
coupling the device of any one of claims 29-35 with a receiver plate to form a transfer assembly in a first position (e.g., an upright position); and
centrifuging the transfer assembly around an axis of rotation, wherein when the transfer assembly is centrifuged, the device is positioned closer to the axis of rotation than the receiver plate,
wherein each opening of the device is aligned with a different receiver well of the receiver plate, whereby an agent in at least one enclosure of the device is transferred to the corresponding receiver well.
